(19) United States
(12) Patent Application Publication
(10) Pub. No.: US 2026/0366798 A1
(43) Pub. Date: Nov. 19, 2026

(54) REFRIGERATOR

(71) Applicant: SAMSUNG ELECTRONICS CO., LTD., Suwon-si (KR)

(72) Inventors: Kitae PARK, Suwon-si (KR); Kilyun JEONG, Suwon-si (KR)

(73) Assignee: SAMSUNG ELECTRONICS CO., LTD., Suwon-si (KR)

(21) Appl. No.: 19/732,087

(22) Filed: Jul. 6, 2026

Related U.S. Application Data
(63) Continuation of application No. PCT/KR2024/017366, filed on Nov. 6, 2024.

(30) Foreign Application Priority Data
Jan. 5, 2024 (KR) 10-2024-0002523

(51) Int. Cl. F25D 23/02; E05F 15/73; F25D 29/00

(52) U.S. Cl. CPC F25D 23/028; E05F 15/73; F25D 29/005; E05Y 2400/44; E05Y 2900/31; F25D 2323/021

(57) ABSTRACT

A refrigerator includes a main body defining a storage compartment, a door to open or close at least a portion of the storage compartment, and a door opening device to open the door. The door includes a door panel defining a surface of the door, a lower cap on a lower side of the door panel, and including a handle and a sensor mounting portion in front of the handle, and a touch sensor on the sensor mounting portion and to receive a touch signal to operate the door opening device. The touch sensor includes a bottom touch portion below the sensor mounting portion and to receive a touch signal from a lower side of the touch sensor, and a front touch portion below the sensor mounting portion, in front of the bottom touch portion, and to receive a touch signal from a front side of the touch sensor.

### CROSS-REFERENCE TO RELATED APPLICATIONS

This application is a Continuation Application of International Application PCT/KR2024/017366 filed on Nov. 6, 2024, which claims benefit of Korean Patent Application No. 10-2024-0002523, filed on Jan. 5, 2024, at the Korean Intellectual Property Office, the disclosures of which are incorporated by reference herein in their entireties.

### BACKGROUND

### 1. Field

The disclosure relates to a refrigerator having a door opening device.

### 2. Description of the Related Art

A refrigerator is an appliance for keeping food fresh, including a main body having a storage compartment, and a cold air supply system for supplying cold air to the storage compartment. The storage compartment includes a refrigerating compartment maintained at approximately 0 to 5 degrees Celsius to keep food refrigerated, and a freezing compartment maintained at approximately −17 to −23 degrees Celsius to keep food frozen. A door is provided on the front of the main body to open and close the storage compartment. The storage compartment is provided to be open at a front side for insertion and removal of food.

The refrigerator repeats a cooling cycle in which a refrigerant is compressed, condensed, expanded, and evaporated using a compressor, a condenser, an expander, and an evaporator. At this time, both the freezing compartment and the refrigerating compartment may be cooled by a single evaporator provided on the freezing compartment side, or the freezing compartment and the refrigerating compartment may each be provided with an evaporator and cooled independently.

The refrigerator includes a door for opening or closing the storage compartment. The door is rotatably provided with respect to the main body to open or close the storage compartment.

The door may be provided such that a user may open or close the door by grasping a handle provided on the door and rotating the door about the main body. Alternatively, the refrigerator may include a door opening device that opens the door to facilitate opening of the door. A user may operate the door opening device by inputting a door opening signal to an input device.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

An aspect of the present disclosure provides a refrigerator having a door opening device configured to open a door and a touch sensor configured to receive a touch signal for operating the door opening device.

An aspect of the present disclosure provides a refrigerator having a touch sensor with an improved structure to enhance user convenience.

An aspect of the present disclosure provides a refrigerator having a touch sensor with an improved structure to efficiently receive a touch signal.

An aspect of the present disclosure provides a refrigerator having a touch sensor with an improved structure such that the precision and accuracy of touch signal input is improved.

An aspect of the present disclosure provides a refrigerator having an improved structure to prevent a touch sensor from interfering with an adjacent door and to prevent the touch sensor from erroneously detecting a signal.

Technical tasks to be achieved in this document are not limited to the technical tasks mentioned above, and other technical tasks not mentioned will be clearly understood by those skilled in the art from the description below.

A refrigerator according to an embodiment of the disclosure may include a main body defining a storage compartment, a door to open or close at least a portion of the storage compartment, and a door opening device to open the door. The door may include a door panel defining a surface of the door, a lower cap on a lower side of the door panel, and may include a handle and a sensor mounting portion in front of the handle, and a touch sensor on the sensor mounting portion and configured to receive a touch signal to operate the door opening device. The touch sensor may include a bottom touch portion below the sensor mounting portion and configured to receive a touch signal from a lower side of the touch sensor, and a front touch portion below the sensor mounting portion, in front of the bottom touch portion, and configured to receive a touch signal from a front side of the touch sensor.

A refrigerator according to an embodiment of the disclosure may include a main body defining a storage compartment, a door configured to open or close the storage compartment, and a door opening device configured to open the door. The door may include a lower cap on a first portion of the door and including a handle and a sensor mounting portion in front of the handle, a touch sensor coupled to the sensor mounting portion and configured to receive a touch signal to operate the door opening device. The touch sensor may include a printed circuit board, and a signal conductor on the printed circuit board and below the sensor mounting portion, the signal conductor configured to transmit a touch signal to the printed circuit board.

A refrigerator according to an embodiment of the disclosure may include a main body defining a storage compartment, a door configured to open or close the storage compartment, and a door opening device configured to open the door. The door may include a door panel defining a surface of the door, a lower cap on a first side of the door panel and including a handle and a sensor mounting portion in front of the handle and recessed upwardly from an opening, and a touch sensor in the sensor mounting portion and configured to receive a touch signal to operate the door opening device. The touch sensor may include a bottom touch portion in the opening of the sensor mounting portion and configured to receive a touch signal from a first side of the touch sensor.

### DESCRIPTION OF DRAWINGS

The above and other aspects, features, and advantages of certain embodiments of the present disclosure will be more apparent from the following description taken in conjunction with the accompanying drawings, in which:

FIG. 1 is a front view illustrating a state in which doors of a refrigerator according to an embodiment of the present disclosure are closed;

FIG. 2 is a perspective view illustrating a state in which doors of a refrigerator according to an embodiment of the present disclosure are open;

FIG. 3 is a top view illustrating some configurations of the refrigerator according to an embodiment of the present disclosure from above;

FIG. 4 is an enlarged view illustrating a main body, a right door, and a door opening device configured to open the right door when the right door of a refrigerator according to an embodiment of the present disclosure is closed;

FIG. 5 is a view illustrating a state in which the right door is being opened by the door opening device of the refrigerator according to an embodiment of the present disclosure;

FIG. 6 is an exploded view of the door of the refrigerator according to an embodiment of the present disclosure;

FIG. 7 is an enlarged view of some configurations of the door, such as a door panel, a lower cap, and a touch sensor, of the refrigerator according to an embodiment of the present disclosure;

FIG. 8 is a view illustrating some configurations of the door, such as a door panel, a lower cap, and a touch sensor, of the refrigerator according to an embodiment of the present disclosure from below;

FIG. 9 is a view illustrating a state in which a touch sensor is separated from a lower cap of the refrigerator according to an embodiment of the present disclosure;

FIG. 10 is a cross-sectional perspective view illustrating some configurations of the door, such as a door panel, a lower cap, and a touch sensor, of the refrigerator, which are cut away, according to an embodiment of the present disclosure;

FIG. 11 is a rear perspective view illustrating a touch sensor of a refrigerator according to an embodiment of the present disclosure;

FIG. 12 is an exploded view of the touch sensor of the refrigerator according to an embodiment of the present disclosure;

FIG. 13 is an exploded view of the touch sensor of the refrigerator according to an embodiment of the present disclosure;

FIG. 14 is a view illustrating a printed circuit board and a signal conductor of the touch sensor of the refrigerator according to an embodiment of the present disclosure from below;

FIG. 15 is a cross-sectional view illustrating some configurations of a door, such as a door panel, a lower cap, and a touch sensor, of a refrigerator, which are cut away, according to an embodiment of the present disclosure;

FIG. 16 is a cross-sectional view illustrating a touch sensor of a refrigerator as viewed from the rear, which is cut away, according to an embodiment of the present disclosure.

FIG. 17 is a view illustrating some configurations of a door, such as a door panel, a lower cap, and a touch sensor, of a refrigerator according to an embodiment of the present disclosure from below;

FIG. 18 is a cross-sectional view illustrating some configurations of the door, such as a door panel, a lower cap, and a touch sensor, of the refrigerator, which are cut away, according to an embodiment of the present disclosure;

FIG. 19 is an enlarged view of a state in which an upper door of a refrigerator is closed, according to an embodiment of the present disclosure; and

FIG. 20 is an enlarged view of a state in which an upper door of a refrigerator is closed, according to an embodiment of the present disclosure.

### DETAILED DESCRIPTION

The embodiments described herein are non-limiting example embodiments, and thus, the disclosure is not limited thereto and may be realized in various other forms. One or more features of at least one embodiment provided herein may be applied to one or more other embodiments provided herein or not provided but consistent with the disclosure. Also, at least one embodiment provided herein is not excluded from being associated with one or more features of another example or another embodiment also provided herein or not provided herein but consistent with the disclosure.

In describing the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, “above”, “below” and the like are defined with reference to the drawings, and are not intended to limit the shape and position of any element.

It will be understood that when the terms “includes”, “comprises”, “including”, and/or “comprising” are used in the disclosure, they specify the presence of the specified features, numbers, steps, operations, components, members, or combinations thereof, but do not preclude the presence or addition of one or more other features, numbers, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through at least one additional element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. “Refrigerating” may be keeping food cold without freezing the food, and for example, the refrigerating compartment may be maintained within a range of 0 degrees Celsius to 5 degrees Celsius. “Freezing” may be freezing food or keeping food frozen, and for example, the freezing compartment may be maintained within a range of −23 degrees Celsius to −17 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming a rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, embodiments according to the present disclosure will be described in detail with reference to the accompanying drawings.

As used herein the following description, the terms “up”, “down”, “front”, “rear”, and the like are defined based on the drawings, and the shape and position of each configuration are not limited by these terms. For example, the terms “front” and “rear” described below may refer to a front and a rear of the refrigerator in an X direction based on the drawings, respectively. The terms “up” and “down” described below may refer to an upward in a Z direction and a downward in the Z direction of the refrigerator based on the drawings, respectively. The terms “left” and “right” described below may refer to a left and a right of the refrigerator in a Y direction based on the drawings, respectively.

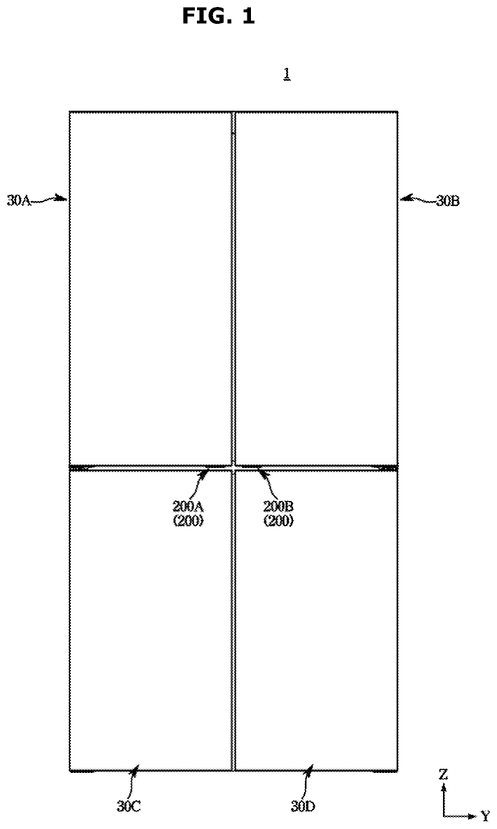

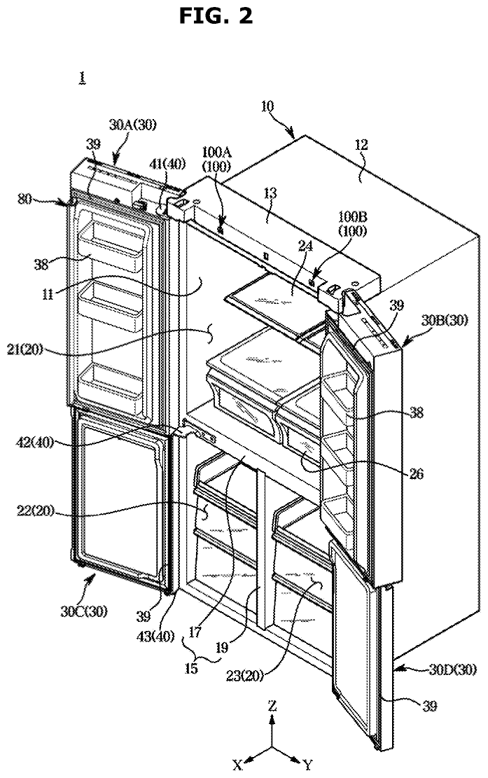

FIG. 1 is a front view illustrating a state in which doors of a refrigerator are closed, according to an embodiment of the present disclosure. FIG. 2 is a perspective view illustrating a state in which doors of a refrigerator are open, according to an embodiment of the present disclosure.

Referring to FIGS. 1 and 2, a refrigerator 1 according to an embodiment of the present disclosure may include a main body 10, a storage compartment 20 provided inside the main body 10, a door 30 configured to open or close the storage compartment 20, and a cooling system configured to supply cold air to the storage compartment 20.

The main body 10 may include an inner case 11 forming the storage compartment 20, and an outer case 12 forming an exterior of the refrigerator 1. The outer case 12 may be formed to have the shape of a box with a substantially open front. The outer case 12 may form an upper surface, a lower surface, left and right side surfaces, a rear surface, or the like of the refrigerator 1. The inner case 11 may be open at the front. The inner case 11 may have the storage compartment 20 provided therein, and may be provided inside the outer case 12. An inner wall of the inner case 11 may form an inner wall of the storage compartment 20.

Between the outer case 12 and the inner case 11 of the main body 10, a main body insulation may be provided such that the outer case 12 and the inner case 11 are thermally insulated from each other. The main body insulation may be foamed between the inner case 11 and the outer case 12 to bond the inner case 11 and the outer case 12 to each other. The main body insulation may prevent heat exchange from occurring between the interior of the storage compartment 20 and the exterior of the main body 10, thereby improving cooling efficiency inside the storage compartment 20. The main body insulation provided in the main body 10 may include urethane foam insulation, expanded polystyrene (EPS) insulation, a vacuum insulation panel, and the like. However, the present disclosure is not limited thereto, and the main body insulation may include a variety of materials.

The main body 10 may further include a top table 13 provided on an upper portion of the main body 10. For example, the top table 13 may be coupled to an upper portion of the outer case 12. The top table 13 may be coupled to an upper surface of the outer case 12.

The top table 13 may cover various electrical components. On an inner side of the top table 13, a receiving space be formed in which various electrical components are received. In an example embodiment, the top table 13 may cover a door opening device 100, which will be described later, and the door opening device 100 may be accommodated inside the top table 13.

The storage compartment 20 may be formed inside the main body 10. In an example embodiment, the storage compartment 20 may include a refrigerating compartment maintained at approximately 0 to 5 degrees Celsius to keep food refrigerated. In an example embodiment, the storage compartment 20 may include a freezing compartment maintained at approximately −23 to −17 degrees Celsius to keep food frozen.

In an example embodiment, the storage compartment 20 may be partitioned into a plurality of areas by partitions 15. For Example, the storage compartment 20 may be partitioned into an upper first storage compartment 21 and lower storage compartments 22 and 23 by a horizontally extending first partition 17. In addition, the lower storage compartments 22 and 23 of the storage compartment 20 may be partitioned into a left second storage compartment 22 and a right third storage compartment 23 by a vertically extending second partition 19. In this case, for example, the first storage compartment 21 may be used as a refrigerating compartment, and both the second storage compartment 22 and the third storage compartment 23 may be used as a freezing compartment, or one of the two may be used as a freezing compartment and the other of the two may be used as a refrigerating compartment.

The partitioning method of the storage compartment 20 and the uses of each of the partitioned storage compartments 21, 22, and 23 described above are only examples, and are not limited thereto.

Shelves 24 on which food may be placed and storage containers 26 for storing food may be provided inside the storage compartment 20.

The refrigerator 1 may include a cooling system configured to generate cold air using a cooling cycle, and supply the generated cold air to the storage compartment 20. The cooling system may generate cold air using a refrigeration cycle in which a refrigerant is compressed, condensed, expanded, and evaporated. In an example embodiment, the cooling system may include a compressor, a condenser, an expansion valve, an evaporator, a blower fan, and the like. The cold air generated by the cooling system may be supplied to the storage compartment 20 through a cold air supply duct formed in a rear portion of the inner case 11.

The door 30 may be configured to open or close the storage compartment 20. The door 30 may be provided to open or close an opening formed at one side of the main body 10. The door 30 may be rotatably provided with respect to the main body 10.

An outer surface of the door 30 may form part of the exterior of the refrigerator 1. In a closed position of the door 30, the outer surface of the door 30 may form at least a portion of a front exterior of the refrigerator 1. In the closed position of the door 30, an inner surface of the door 30 may face the interior of the storage compartment 20. As used herein, the inner surface of the door 30 may refer to one surface of the door 30 that faces the storage compartment 20 when the door 30 closes the storage compartment 20. Further, the outer surface of the door 30 as used herein may refer to the other surface opposite to the inner surface that faces the storage compartment 20 when the door 30 closes the storage compartment 20, and refer to a front surface of the door 30 as seen when the refrigerator 1 is viewed from the front.

A door basket 38 for storing food may be provided on the inner surface of the door 30. A door gasket 39 configured to seal a gap between the door 30 and the main body 10 to prevent cold air of the storage compartment 20 from escaping may be provided on the inner surface of the door 30.

The refrigerator 1 may include an upper door and a lower door arranged to parallel to each other in a vertical direction (Z). The refrigerator 1 may include a left door and a right door arranged side by side in a horizontal direction (Y). The refrigerator 1 may include a plurality of doors 30A, 30B, 30C and 30D configured to open or close the respective partitioned storage compartments 21, 22, and 23.

The first storage compartment 21 may be opened or closed by a pair of upper doors 30A and 30B. The refrigerator 1 may include a first door 30A configured to open or close a portion of the first storage compartment 21, and a second door 30B configured to open or close a different portion of the first storage compartment 21. The first door 30A and the second door 30B may be provided to be rotatable independently of each other with respect to the main body 10. The first door 30A and the second door 30B may be arranged side by side in the horizontal direction (Y direction) to each other. In an example embodiment, the first door 30A may be configured to open or close a left portion of the first storage compartment 21, and the second door 30B may be configured to open or close a right portion of the first storage compartment 21.

Any one door (e.g., the first door 30A) of the pair of upper doors 30A and 30B may be provided with a rotating bar 80 provided to be rotatable with respect to the one door and configured to cover a gap between the pair of upper doors 30A and 30B when the pair of upper doors 30A and 30B close the first storage compartment 21.

The second storage compartment 22 may be opened or closed by a left lower door 30C. The refrigerator 1 may include a third door 30C configured to open or close the second storage compartment 22. The third door 30C may be rotatably provided with respect to the main body 10. In an example embodiment, the first door 30A and the third door 30C may be arranged parallel to each other in the vertical direction (Z).

The third storage compartment 23 may be opened or closed by a right lower door 30D. The refrigerator 1 may include a fourth door 30D configured to open or close the third storage compartment 23. The fourth door 30D may be rotatably provided with respect to the main body 10. In an example embodiment, the second door 30B and the fourth door 30D may be arranged parallel to each other in the vertical direction (Z). In addition, the third door 30C and the fourth door 30D may be arranged side by side in the horizontal direction (Y) to each other.

Each of the plurality of doors 30A, 30B, 30C and 30D may be provided with a handle. A user may open or close each of the doors 30A, 30B, 30C and 30D by grasping the handle provided on each of the plurality of doors 30A, 30B, 30C and 30D with a hand. Stated differently, a user may open or close each of the storage compartments 21, 22, and 23 by grasping the handle provided on each of the plurality of doors 30A, 30B, 30C and 30D with a hand. In an example embodiment, the handle provided on each of the plurality of doors 30A, 30B, 30C and 30D may include a recessed groove shape for gripping.

As will be described below, the upper doors may be opened by the door opening device 100. For example, the first door 30A may be opened by a first door opening device 100A disposed on the left side. For example, the second door 30B may be opened by a second door opening device 100B disposed on the right side.

As will be described below, the upper door may include a touch sensor 200 configured to receive a touch signal to actuate the door opening device 100. For example, the first door 30A may include a first touch sensor 200A configured to receive a touch signal for operating the first door opening device 100A. For example, the second door 30B may include a second touch sensor 200B configured to receive a touch signal for operating the second door opening device 100B.

The refrigerator 1 may include a hinge 40 connecting the main body 10 and the door 30. The hinge 40 may be provided to allow the door 30 to be rotatable with respect to the main body 10.

The hinge 40 may be fixed to the main body 10. For example, the hinge 40 may be coupled to the outer case 12.

The hinge 40 may rotatably support the door 30. The door 30 may be rotatably coupled to the main body 10 by the hinge 40.

For example, the refrigerator 1 may include a plurality of hinges 41, 42, and 43 configured to support the plurality of doors 30A, 30B, 30C and 30D, respectively. For example, the refrigerator 1 may include a pair of upper door hinges 41 coupled to an upper portion of the main body 10 to rotatably support the first door 30A and the second door 30B, respectively. In addition, for example, the refrigerator 1 may include a pair of lower door hinges 43 coupled to a lower portion of the main body 10 to rotatably support the third door 30C and the fourth door 30D, respectively. In addition, for example, the refrigerator 1 may include a pair of intermediate hinges 42 disposed between the upper door hinges 41 and the lower door hinges 43 and coupled to a middle portion of the main body 10 (more particularly, the first partition 17) to rotatably support each of the first door 30A, the second door 30B, the third door 30C, and the fourth door 30D.

The configuration of the refrigerator 1 described above with reference to FIGS. 1 and 2 is merely an example to illustrate a refrigerator according to an embodiment the present disclosure, and the present disclosure is not limited thereto. A refrigerator according to an embodiment the present disclosure may be provided to include various configurations for performing a function of supplying cold air to a storage compartment for storing food items.

The type of refrigerator to which the refrigerator according to an embodiment the present disclosure is applied is not limited to the type of refrigerator 1 shown in the drawings, and the refrigerator according to an embodiment the present disclosure may include various types of refrigerators, such as a side-by-side type, a French door type, a bottom mounted freezer (BMF) type, a top mounted freezer (TMF) type, and the like.

Furthermore, the refrigerator 1 according to an embodiment of the present disclosure has been described above as an example of the present disclosure on the premise that it is an indirect-cooled refrigerator, but the present disclosure is not limited thereto and may be applied to a direct-cooled refrigerator.

However, for ease of description, the refrigerator according to an embodiment present disclosure will be described in detail below based on the refrigerator 1 according to the embodiment shown in FIGS. 1 to 20.

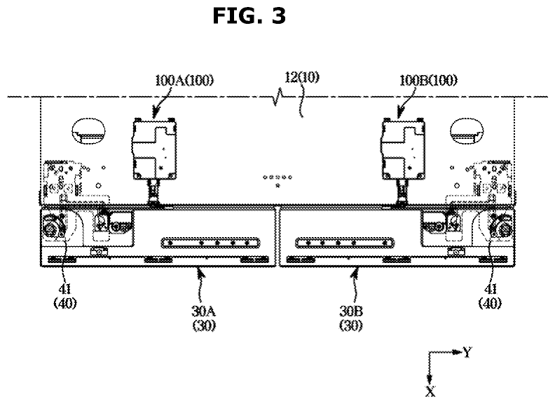

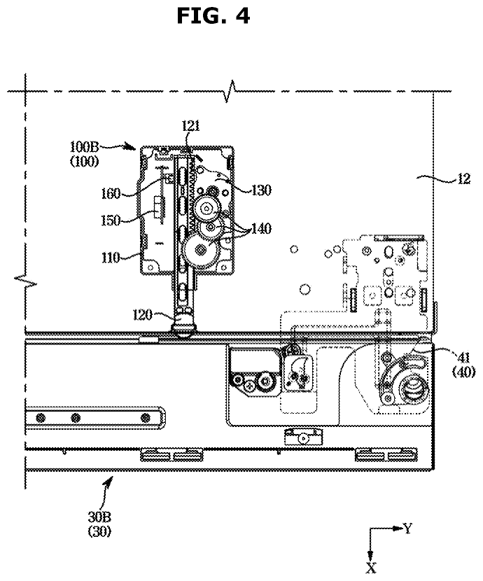

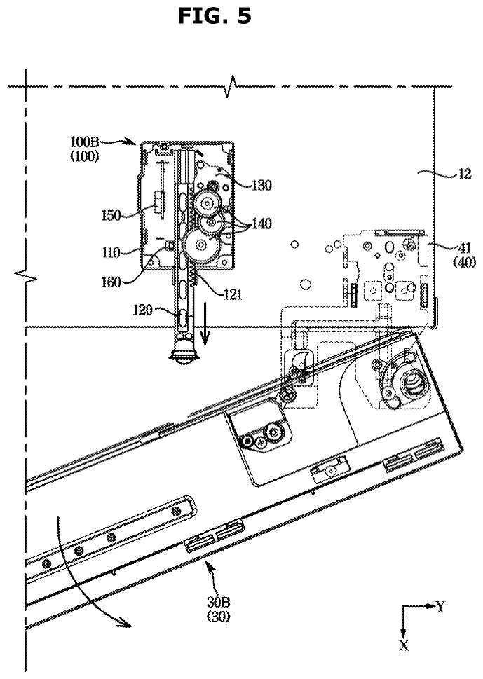

FIG. 3 is a top view illustrating some configurations of a refrigerator as viewed from above, according to an embodiment of the present disclosure. FIG. 4 is an enlarged view illustrating a main body, a right door, and a door opening device configured to open the right door when the right door of a refrigerator is closed, according to an embodiment of the present disclosure. FIG. 5 is a view illustrating a state in which the right door is being opened by the door opening device of the refrigerator according to an embodiment of the present disclosure.

Referring to FIGS. 3 to 5, the refrigerator 1 according to an embodiment of the present disclosure may include the door opening device 100 configured to open the door 30. The door opening device 100 may be configured to rotate the door 30 with respect to the main body 10 in order to open the storage compartment 20. For example, the door opening device 100 may be configured to press the door 30 to open the door 30.

For example, the refrigerator 1 may include a first door opening device 100A configured to open the first door 30A, and a second door opening device 100B configured to open the second door 30B. Stated differently, the door opening device 100 may be configured to open the first storage compartment 21.

The first door opening device 100A may be configured to open the first door 30A. The first door opening device 100A may be configured to press the first door 30A to open a portion of the first storage compartment 21.

In addition, the second door opening device 100B may be configured to open the second door 30B. The second door opening device 100B may be configured to press the second door 30B to open a different portion of the first storage compartment 21.

The operation of the first door opening device 100A to open the first door 30A and the operation of the second door opening device 100B to open the second door 30B may be performed independently of each other.

The door opening device 100 may be mounted to the main body 10. In an example embodiment, the door opening device 100 may be mounted to an upper portion of the main body 10. For example, the door opening device 100 may be accommodated inside the top table 13. The door opening device 100 may be covered upward by the top table 13. The door opening device 100 may be disposed on the upper surface of the outer case 12. In an example embodiment, the first door opening device 100A may be disposed on the left side based on the center in the upper portion of the main body 10, and the second door opening device 100B may be disposed on the right side based on the center in the upper portion of the main body 10. In other words, the first door opening device 100A and the second door opening device 100B may be disposed parallel to each other in the horizontal direction (Y). The first door opening device 100A mounted on the upper portion of the main body 10 may be configured to press the upper portion of the first door 30A, and the second door opening device 100B mounted on the upper portion of the main body 10 may be configured to press the upper portion of the second door 30B.

However, the present disclosure is not limited thereto, and the door opening device 100 may be mounted at various positions on the main body 10, and may be configured to open the first storage compartment 21 by pressing various portions other than the upper portion of the first door 30A or the second door 30B. For example, unlike that shown in FIG. 2, the door opening device 100 may be mounted to the first partition 17 and configured to press the lower portion of the first door 30A or the second door 30B.

The first door opening device 100A and the second door opening device 100B may have a structure corresponding to each other. FIGS. 4 and 5 illustrate in detail a structure of the second door opening device 100B configured to open the second door 30B, and the structure of the second door opening device 100B shown in FIGS. 4 and 5 may be correspondingly applied to the structure of the first door opening device 100A.

Referring to FIGS. 4 and 5, the door opening device 100 may include a door pusher 120 configured to press the door 30 to open the door 30. The door pusher 120 may be movably provided with respect to the main body 10. The door pusher 120 may be configured to press the door 30 as it moves relative to the main body 10. For example, the door pusher 120 may press the door 30 while moving forwardly from the main body 10 side toward the door 30, thereby causing the closed door 30 to open.

In an example embodiment, as shown in FIGS. 4 and 5, the door pusher 120 may be linearly reciprocally provided with respect to the main body 10. The door pusher 120 may be linearly movable in the front-to-back direction (X) with respect to the main body 10. Alternatively, the door pusher 120 may be nonlinearly moved with respect to the main body 10.

The door opening device 100 may include a pusher case 110 supporting the door pusher 120. The pusher case 110 may movably support the door pusher 120. The pusher case 110 may form a receiving space for receiving at least a portion of the door pusher 120. As shown in FIGS. 4 and 5, the door pusher 120 may be provided movably between a position maximally retracted into the receiving space of the pusher case 110 and a position forwardly withdrawn from the receiving space of the pusher case 110.

The pusher case 110 may be mounted to the main body 10. The pusher case 110 may be secured to the main body 10. In an example embodiment, the pusher case 110 may be coupled to the top table 13. However, the present discourse is not limited thereto, and the pusher case 110 may be coupled to various positions of the main body 10.

The door opening device 100 may include a power source 130 configured to generate power to open the door 30. The power source 130 may be configured to generate power to move the door pusher 120. In an example embodiment, the power source 130 may include a drive motor, and a motor driver connected to the drive motor. The drive motor may generate power by receiving a drive current from the motor driver. The motor driver may be electrically connected to a controller of the refrigerator 1, and may operate based on a control signal received from the controller. In other words, the power source 130 may be controlled by the controller of the refrigerator 1.

The power source 130 may be supported by the pusher case 110. The power source 130 may be accommodated inside the pusher case 110.

The door opening device 100 may include a power transmission member 140 configured to transmit power generated by the power source 130 to the door pusher 120.

In an example embodiment, the power transmission member 140 may include at least one gear. As shown in FIGS. 4 and 5, the power transmission member 140 may include a plurality of gears. The door pusher 120 may include a pusher gear portion 121 configured to mesh with the power transmission member 140, and the door pusher 120 may receive power from the gears of the power transmission member 140 via the pusher gear portion 121. In an example embodiment, the power transmission member 140 and the pusher gear portion 121 may be configured as a rack-and-pinion gear structure.

The power transmission member 140 may be supported by the pusher case 110. The power transmission member 140 may be accommodated inside the pusher case 110.

The door opening device 100 may include a position detection sensor 150 configured to detect a position of the door pusher 120. The position detection sensor 150 may detect the position of the door pusher 120 in a variety of ways. In an example embodiment, the position detection sensor 150 may include various types of magnetic field sensors, such as a hall sensor, which is configured to detect a magnetic field of a magnet 160 mounted on the door pusher 120. The controller may control the power source 130 to move or stop the door pusher 120 based on an electrical signal received from the position detection sensor 150.

In an example embodiment, the position detection sensor 150 may be supported by the pusher case 110. The position detection sensor 150 may be accommodated within the pusher case 110.

By such a configuration, the door opening device 100 may open the door 30. The door opening device 100 may operate based on a door opening signal to open the door 30. The door opening signal for opening the door 30 may be generated based on user input for opening the door 30. The user input for opening the door 30 may include a touch signal for operating the door opening device 100, input via the touch sensor 200.

The touch sensor 200 may be configured to receive a touch signal for operating the door opening device 100. The touch sensor 200 may receive a touch signal input by a touch act of a user. For example, the touch sensor 200 may receive a touch signal by a user touching a portion of the touch sensor 200, or by placing at least a portion of a body (e.g., a hand, etc.) in close proximity to the touch sensor 200. For example, the touch sensor 200 may include a capacitance sensor configured to detect a change in capacitance caused by a user's touch action. The touch signal may be input to the touch sensor 200 based on a change in capacitance caused by the user's touch action, and the touch sensor 200 may generate a door opening signal based on the change in capacitance caused by the user's touch action.

The door opening device 100 may open the door 30 based on the touch sensor 200 receiving the touch signal. The controller of the refrigerator 1 may control the power source 130 to move the door pusher 120 in a direction to press the door 30, i.e., to open the door 30, based on the touch sensor 200 receiving the touch signal.

The first door 30A and the second door 30B may each include the touch sensor 200. For example, the first door 30A may include a first touch sensor 200A configured to receive a touch signal for operating the first door opening device 100A, and the first door opening device 100A may open the first door 30A based on the first touch sensor 200A receiving the touch signal. Further, the second door 30B may include a second touch sensor 200B configured to receive a touch signal for operating the second door opening device 100B, and the second door opening device 100B may open the second door 30B based on the second touch sensor 200B receiving the touch signal.

The structure of the door opening device 100 described above with reference to FIGS. 3 to 5 is only an example, and the present disclosure is not limited thereto. The refrigerator 1 according to an embodiment of the present disclosure may include a door opening device of various structures capable of opening the door 30 based on a touch signal being input via the touch sensor 200 provided on the door 30.

For example, in contrast to what has been describe above, the refrigerator 1 may include a door opening device mounted to the door 30 and configured to open the door 30. Such a door opening device may include, for example, a main body pusher movably mounted relative to the door 30 and configured to press the main body 10 while moving toward the main body 10, and may be configured to open the door 30 in reaction to the main body pusher pressing the main body 10.

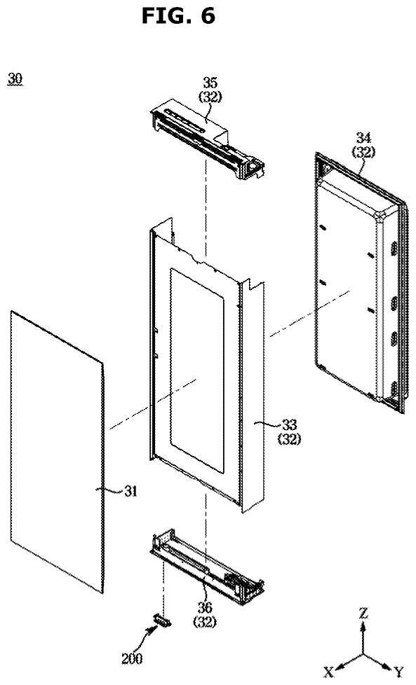

Hereinafter, the structure of the touch sensor 200 provided on the door 30 will be described in more detail with reference to FIGS. 6 to 20.

FIG. 6 is an exploded view of the door of the refrigerator according to an embodiment of the present disclosure.

Referring to FIG. 6, the door 30 of the refrigerator 1 according to an embodiment of the present disclosure may include a door panel 31. The door panel 31 may form an outer surface of the door 30. The door panel 31 may form a front surface of the door 30. The front surface of the door 30 as used herein may refer to one surface of the door 30 facing the front of the refrigerator 1 when the door 30 is closed. Hereinafter, in defining the positional relationship of the configurations included in the door 30, a direction in which the door panel 31 faces is defined as the front of the door 30, and an opposite direction is defined as the rear of the door 30.

In an example embodiment, the door panel 31 may have a substantially flat rectangular plate shape, but the shape thereof is not limited thereto.

The door 30 may include a door body 32. The door body 32 may support the door panel 31. The door panel 31 may be mounted to the door body 32. In an example embodiment, the door panel 31 may be detachably mounted to the door body 32. The door body 32 may be disposed on a rear side of the door panel 31. The door panel 31 may be mounted to a front portion of the door body 32.

The door body 32 may be coupled to the hinge 40. The door body 32 may be rotatably coupled to the main body 10 via the hinge 40.

The door body 32 may include a front frame 33. The front frame 33 may be provided at a front portion of the door body 32 facing the door panel 31. The front frame 33 may form a front surface of the door body 32. The front frame 33 may be disposed on a rear side of the door panel 31. The door panel 31 may be mounted to the front frame 33.

The door body 32 may include a rear frame 34. The rear frame 34 may be provided on a rear portion of the door body 32 facing the storage compartment 20 when the door 30 is closed. The rear frame 34 may form the rear surface of the door body 32. The rear frame 34 may be disposed on a rear side of the front frame 33. In an example embodiment, the rear frame 34 may include a dyke protruding rearwardly to allow the door basket 38 (see FIG. 2) to be mounted.

In an example embodiment, the front frame 33 and the rear frame 34 may be formed as separate configurations from each other. The front frame 33 and the rear frame 34 may be coupled to each other. For example, the rear frame 34 may be coupled to a rear portion of the front frame 33.

Alternatively, In an example embodiment, the front frame 33 and the rear frame 34 may be integrally formed with each other.

The door body 32 may include an upper cap 35. The upper cap 35 may form an upper surface of the door body 32. Further, the upper cap 35 may form an upper surface of the door 30.

The upper cap 35 may be disposed on an upper side of the door panel 31. The upper cap 35 may be coupled to an upper portion of the door panel 31. The upper cap 35 may support the upper portion of the door panel 31. In an example embodiment, the upper cap 35 may support an upper end of the door panel 31. The upper cap 35 may be coupled to an upper portion of the front frame 33. The upper cap 35 may be coupled to an upper portion of the rear frame 34.

In an example embodiment, the upper door hinges 41 described above may be coupled to the upper cap 35.

The door body 32 may include a lower cap 36. The lower cap 36 may form a lower surface of the door body 32. Further, the lower cap 36 may form a lower surface of the door 30.

The lower cap 36 may be disposed on a lower side of the door panel 31. The lower cap 36 may be coupled to a lower portion of the door panel 31. The lower cap 36 may support a lower portion of the door panel 31. In an example embodiment, the lower cap 36 may support a lower end of the door panel 31. The lower cap 36 may be coupled to a lower portion of the front frame 33. The upper cap 35 may be coupled to a lower portion of the rear frame 34.

In an example embodiment, the intermediate hinge 42 described above may be coupled to the lower cap 36.

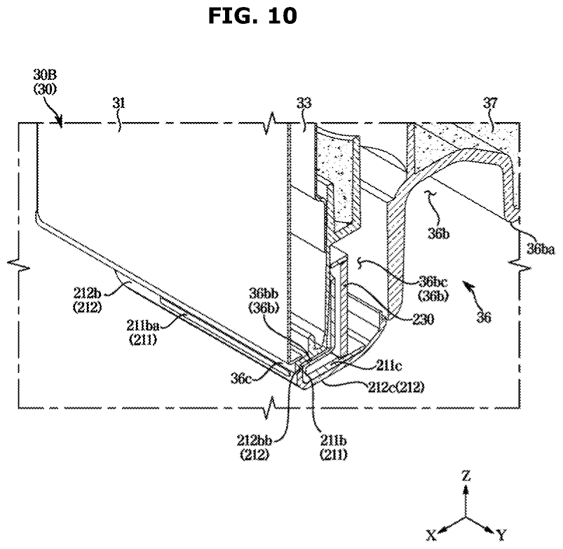

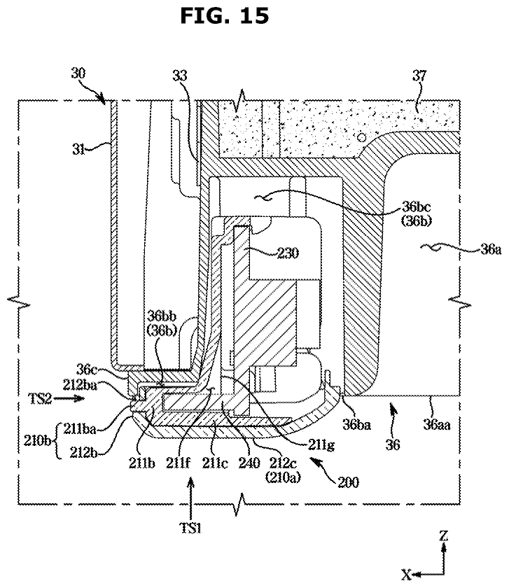

A door insulation 37 (see FIGS. 10 and 15) may be provided inside the door body 32. A foaming space may be formed inside the door body 32 so that the door insulation 37 may be foamed. In an example embodiment, the foaming space may be formed between the front frame 33, the rear frame 34, the upper cap 35, and the lower cap 36. The door insulation 37 may prevent heat exchange from occurring between the interior and the exterior of the storage compartment 20 through the door 30 when the door 30 is closed. The door insulation 37 may improve thermal insulation performance between the interior of the storage compartment 20 and the exterior of the door 30.

The door insulation 37 may include urethane foam insulation, expanded polystyrene (EPS) insulation, a vacuum insulation panel, and the like. However, the present disclosure is not limited thereto, and the door insulation 37 may include various materials.

The door 30 may include the touch sensor 200. The touch sensor 200 may be configured to receive a touch signal for operating the door opening device 100.

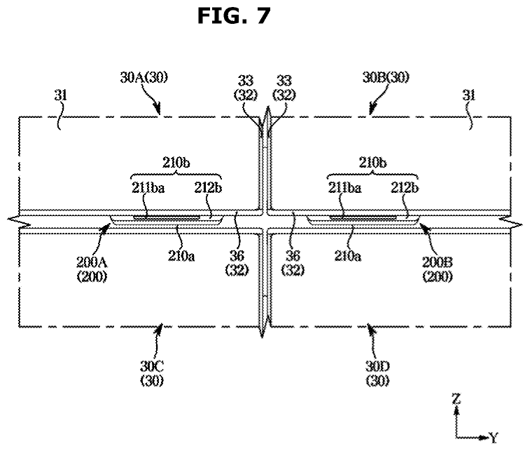

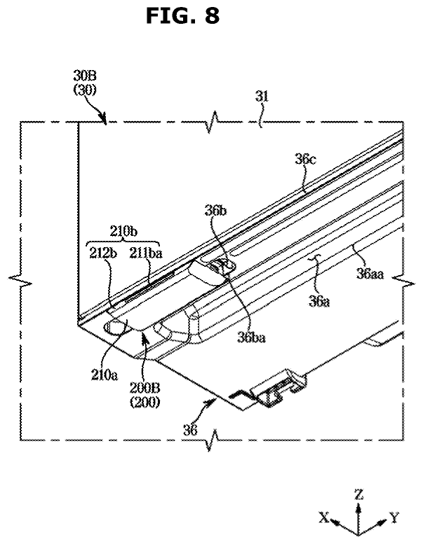

As shown in FIGS. 7 to 10, and the like, a handle 36a (see FIG. 8 etc.), which is provided for a user to grasp by hand to open or close the door 30, may be disposed on a lower portion of the door 30. For example, the handle 36a may be disposed on the lower cap 36.

The touch sensor 200 may be disposed adjacent to a position of the handle 36a. In other words, the touch sensor 200 may be disposed on the lower portion of the door 30. For example, the touch sensor 200 may be mounted to a lower portion of the door body 32. The touch sensor 200 may be mounted to the lower cap 36. As such, with the touch sensor 200 disposed adjacent to the position of the handle 36a, a touch signal may be input to the touch sensor 200 simply by a user performing a natural and simple act that is typically performed to open the door 30, such as reaching for the handle 36a. Thus, a user may easily input a touch signal to the touch sensor 200 without even being aware of the intent to input a touch signal to the touch sensor 200. Furthermore, even without necessarily learning a manual on how to input a touch signal to the touch sensor 200, a user may easily learn how to input a touch signal to the touch sensor 200 to operate the door opening device 100 in a process of using a product. Such an arrangement of the touch sensor 200 may allow the touch sensor 200 to more efficiently receive touch signals for opening the door 30, and may improve user convenience.

While the door 30 has been described above based on an embodiment in which the door 30 includes the door body 32 and the door panel 31 detachably mounted to the door body 32, and the door body 32 is formed by the front frame 33, the rear frame 34, the upper cap 35, and the lower cap 36 coupled together in a separate configuration from each other, but the present disclosure is not limited thereto. For example, at least some configurations of the front frame 33, the rear frame 34, the upper cap 35, and the lower cap 36 may be integrally formed with each other, and the touch sensor 200 may be mounted to a portion of the door body 32 corresponding to the lower cap 36. Alternatively, for example, the door panel 31 and the door body 32 may be integrally formed with each other, and the touch sensor 200 may be mounted to a portion of the door 30 corresponding to the lower cap 36 of the door body 32 throughout the door 30.

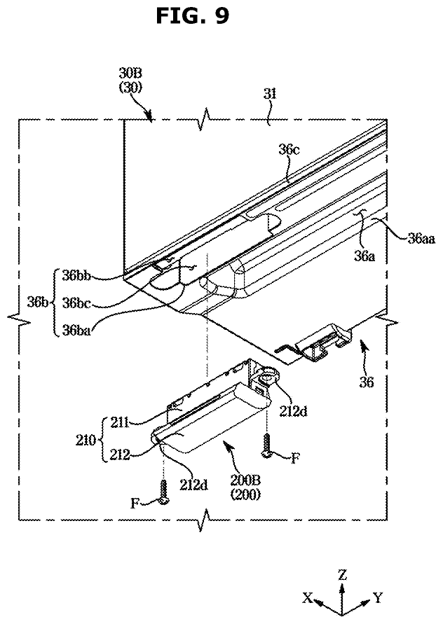

FIG. 7 is an enlarged view of some configurations of a door, such as a door panel, a lower cap, and a touch sensor, of the refrigerator according to an embodiment of the present disclosure. FIG. 8 is a view illustrating some configurations of the door, such as a door panel, a lower cap, and a touch sensor, of the refrigerator according to an embodiment of the present disclosure from below. FIG. 9 is a view illustrating a state in which a touch sensor is separated from a lower cap of the refrigerator according to an embodiment of the present disclosure. FIG. 10 is a cross-sectional perspective view illustrating some configurations of a door, such as a door panel, a lower cap, and a touch sensor, of a refrigerator, which are cut away, according to an embodiment of the present disclosure.

In an embodiment of the present disclosure, the lower cap 36 of the first door 30A and the lower cap 36 of the second door 30B may have symmetrical shapes to each other. Further, the first touch sensor 200A and the second touch sensor 200B may have structures corresponding to each other. FIGS. 8 to 10 illustrate in detail the structures of the second door 30B and the second touch sensor 200B mounted on the lower cap 36 of the second door 30B, and the structure of the second touch sensor 200B shown in FIGS. 8 to 10 may be correspondingly applied to the structure of the first touch sensor 200A.

Referring to FIGS. 7 to 10, the door 30 of the refrigerator 1 according to an embodiment of the present disclosure may include the handle 36a. The handle 36a may be provided on the lower portion of the door 30. The lower cap 36 may include the handle 36a.

The handle 36a may be formed by recessing a lower surface of the lower cap 36 upwardly. For example, the lower cap 36 may include a handle opening 36aa formed in the lower surface, and the handle 36a may be formed by recessing upwardly from the handle opening 36aa. The handle 36a may have a shape of a groove concavely recessed upwardly from the handle opening 36aa. A user may access the handle 36a through the handle opening 36aa. The user may open the door 30 by grasping the handle 36a with hand.

At least a portion of the handle 36a may be arranged adjacent to a central portion of the refrigerator 1. For example, the handle 36a of the first door 30A may be arranged adjacent to a right end of the first door 30A. The handle 36a of the second door 30B may be arranged adjacent to a left end of the second door 30B. Since the right end of the first door 30A is farther from a rotation axis of the first door 30A than the left end, a user may easily open the first door 30A with less force by gripping a portion of the handle 36a adjacent to the right end of the first door 30A. Similarly, since the left end of the second door 30B is farther from a rotation axis of the second door 30B than the right end, a user may easily open the second door 30B with less force by gripping a portion of the handle 36a adjacent to the left end of the second door 30B.

The handle 36a may extend in the horizontal direction (Y). The handle 36a may extend in the horizontal direction (Y) from one side adjacent to the central portion of the refrigerator 1 toward the other side.

The shape of the handle 36a is not limited to those shown in FIGS. 7 to 10, and may have various shapes to allow a user to grip by hand.

The touch sensor 200 may be mounted on the lower cap 36 of the door 30. The touch sensor 200 may be mounted at a lower portion of the lower cap 36. The touch sensor 200 may be mounted to the lower cap 36 from below.

The touch sensor 200 may be disposed in front of the handle 36a. In other words, when the door 30 is closed, the touch sensor 200 may be positioned ahead of the handle 36a. The lower cap 36 may include a sensor mounting portion 36b on which the touch sensor 200 is mounted. The sensor mounting portion 36b may be formed forward of the handle 36a. As the touch sensor 200 is positioned forward of the handle 36a, the touch sensor 200 may be positioned closer to a user than the handle 36a when the door 30 is closed. Thus, it is possible for the user to touch the touch sensor 200 first before gripping the handle 36a by hand, the touch sensor 200 may receive a touch signal more efficiently, and the user may input a touch signal to the touch sensor 200 more conveniently.

The touch sensor 200 may include a sensor case 210. The sensor case 210 may form an exterior of the touch sensor 200. The sensor case 210 may accommodate various components of the touch sensor 200.

The sensor case 210 may be mounted on the lower cap 36. The sensor case 210 may be mounted on the sensor mounting portion 36b. In an example embodiment, the sensor case 210 may include a door mounting portion 212d, and may be coupled to the sensor mounting portion 36b by a fastening member F, such as a screw, penetrating the door mounting portion 212d and the sensor mounting portion 36b of the lower cap 36. The present disclosure is not limited thereto, and the sensor case 210 may be coupled to the sensor mounting portion 36b by various configurations.

A portion of the touch sensor 200 may be inserted into the sensor mounting portion 36b. A portion of the sensor case 210 may be inserted into the sensor mounting portion 36b. The sensor case 210 may be mounted to the sensor mounting portion 36b with a portion thereof inserted into the sensor mounting portion 36b.

For example, the sensor mounting portion 36b may be formed by recessing the lower surface of the lower cap 36 upwardly to allow a portion of the sensor case 210 to be inserted. The sensor mounting portion 36b may be formed by recessing upwardly from an opening 36ba formed on the lower surface of the lower cap 36. Stated differently, the sensor mounting portion 36b may be formed by recessing upwardly from the opening 36ba provided at a lower end of the lower cap 36. The sensor mounting portion 36b may have a shape of a groove concavely recessed upward from the opening 36ba. A portion of the touch sensor 200 may be inserted into the sensor mounting portion 36b through the opening 36ba. A portion of the sensor case 210 may be inserted into the sensor mounting portion 36b through the opening 36ba. At least an upper portion of the sensor case 210 may be inserted into the sensor mounting portion 36b and coupled to the lower cap 36.

The sensor mounting portion 36b may be formed in various ways depending on the shape of the sensor case 210. For example, the sensor mounting portion 36b may include a front sensor groove 36bb and a rear sensor groove 36bc having different lengths recessed upwardly from the opening 36ba. The front sensor groove 36bb may be formed forward of the rear sensor groove 36bc. At least a portion of a front portion of the sensor case 210 may be inserted into the front sensor groove 36bb, and at least a portion of a rear portion of the sensor case 210 may be inserted into the rear sensor groove 36bc. In an example embodiment, the front sensor groove 36bb may be formed at a position adjacent to a front end 36c of the lower cap 36. The front sensor groove 36bb and the rear sensor groove 36bc may be connected to each other. In an example embodiment, a vertical direction (Z) length of the rear portion of the sensor case 210 may be longer than a vertical direction (Z) length of the front portion, and a length by which the rear sensor groove 36bc is recessed upwardly from the opening 36ba may be longer than a length by which the front sensor groove 36bb is recessed upwardly from the opening 36ba.

In an example embodiment, a length by which the handle 36a is recessed upwardly from the handle opening 36aa may be longer than a length by which the sensor mounting portion 36b is recessed upwardly from the opening 36ba.

The structure of the sensor mounting portion 36b is not limited to that described above, and the sensor mounting portion 36b may have various structures for stably mounting the sensor case 210.

The touch sensor 200 may be disposed such that at least a portion of the touch sensor 200 is positioned below the door panel 31. In addition, the touch sensor 200 may be disposed such that at least a portion of the touch sensor 200 is positioned below the lower cap 36. A lower portion of the touch sensor 200 may be positioned lower than the door panel 31, and may be positioned lower than the lower cap 36. The touch sensor 200 may be positioned lower than all of the lower cap 36, or at least lower than a portion of the lower cap 36 positioned forward of the touch sensor 200. The touch sensor 200 may be disposed such that a lower portion of the touch sensor 200 protrudes downwardly from the lower cap 36. The touch sensor 200 may be mounted to the lower cap 36 and may be exposed to a lower side of the lower cap 36.

For example, the touch sensor 200 may be disposed to penetrate the opening 36ba of the sensor mounting portion 36b. The sensor case 210 may be disposed to penetrate the opening 36ba of the sensor mounting portion 36b. A portion of the sensor case 210 may be disposed on the inside of the sensor mounting portion 36b. Another portion of the sensor case 210 may be disposed on the outside of the sensor mounting portion 36b. In other words, a portion of the sensor case 210 may be inserted into the sensor mounting portion 36b, and another portion of the sensor case 210 may protrude outside the sensor mounting portion 36b through the opening 36ba. At least an upper portion of the sensor case 210 may be disposed above the opening 36ba and inserted into the sensor mounting portion 36b. At least a lower portion of the sensor case 210 may be disposed below the opening 36ba and disposed outside below the sensor mounting portion 36b. With such a structure, at least a lower portion of the sensor case 210 may be exposed to the outside of the lower cap 36. The sensor case 210 may have at least a lower surface and a front surface exposed to the outside of the lower cap 36.

The touch sensor 200 may receive a touch signal from a lower side. The touch sensor 200 may include a bottom touch portion 210a configured to receive a touch signal from a lower side of the touch sensor 200. The bottom touch portion 210a may be provided on a lower surface of the touch sensor 200. For example, the bottom touch portion 210a may be provided on a lower surface of the sensor case 210. The bottom touch portion 210a may be exposed downwardly to allow a user to touch from below. When a user touches the bottom touch portion 210a, the touch sensor 200 may receive a touch signal from the lower side. The bottom touch portion 210a may be positioned lower than a front touch portion 210b, which will be described later.

The bottom touch portion 210a may be positioned below at least a portion of the lower cap 36. The bottom touch portion 210a may be positioned below the sensor mounting portion 36b. The bottom touch portion 210a may be positioned below a lower end of the sensor mounting portion 36b. The bottom touch portion 210a may be positioned below the opening 36ba of the sensor mounting portion 36b. In other words, the bottom touch portion 210a may be provided on the lower surface of the sensor case 210 disposed on a lower side of the opening 36ba. Thus, the bottom touch portion 210a may be exposed downwardly, and may receive a touch signal from the lower side.

In addition, the bottom touch portion 210a may be positioned below a portion of the lower cap 36 located in front of the bottom touch portion 210a. In other words, the bottom touch portion 210a may be positioned below a portion of the lower cap 36 located in front of the sensor mounting portion 36b. The bottom touch portion 210a may be positioned lower than the front end 36c of the lower cap 36. The bottom touch portion 210a may be positioned lower than a front lower end of the lower cap 36. Further, the bottom touch portion 210a may be positioned lower than a lower end of the door panel 31. As a result, when a user wishes to input a touch signal to the bottom touch portion 210a, it may be prevented from being interfered with by a structure of the door 30 located in front of the bottom touch portion 210a.

The touch sensor 200 may receive a touch signal from the front. The touch sensor 200 may include the front touch portion 210b configured to receive a touch signal from the front of the touch sensor 200. The front of the touch sensor 200 as used herein may refer to the front of the door 30 facing the door panel 31 when the door 30 is closed. The front touch portion 210b may form a front surface of the touch sensor 200. The front surface of the touch sensor 200 as used herein may refer to one surface of the touch sensor 200 facing the front of the door 30 when the door 30 is closed. For example, the front touch portion 210b may form a front surface of the sensor case 210. The front touch portion 210b may be exposed forwardly for a user to touch from the front. When the user touches the front touch portion 210b, the touch sensor 200 may receive a touch signal from the front. The front touch portion 210b may be positioned in front of the bottom touch portion 210a.

The front touch portion 210b may be positioned below at least a portion of the lower cap 36. The front touch portion 210b may be positioned below the sensor mounting portion 36b. The front touch portion 210b may be positioned below the sensor mounting portion 36b. The front touch portion 210b may be positioned lower than the lower end of the sensor mounting portion 36b. The front touch portion 210b may be positioned below the opening 36ba of the sensor mounting portion 36b. In other words, the front touch portion 210b may be provided on the front surface of the sensor case 210 disposed on the lower side of the opening 36ba. As a result, the front touch portion 210b may be exposed downwardly, and may receive a touch signal from the front.

In addition, the front touch portion 210b may be positioned below a portion of the lower cap 36 located in front of the front touch portion 210b. In other words, the front touch portion 210b may be positioned below a portion of the lower cap 36 located in front of the sensor mounting portion 36b. The front touch portion 210b may be positioned lower than the front end 36c of the lower cap 36. The front touch portion 210b may be positioned lower than the front lower end of the lower cap 36. Further, the front touch portion 210b may be positioned lower than the lower end of the door panel 31. As a result, the front touch portion 210b may be exposed without its front being covered by a structure of the door 30 located in front of the front touch portion 210b. In addition, when the user wishes to input a touch signal to the front touch portion 210b, it may be prevented from being interfered with by the structure of the door 30 located in front of the front touch portion 210b.

As shown in FIG. 7, the pair of upper doors 30A and 30B may each include the touch sensor 200. The touch sensor 200 may be mounted on the lower cap 36 of each of the pair of upper doors 30A and 30B. The sensor mounting portion 36b may be formed in the lower cap 36 of each of the pair of upper doors 30A and 30B.

For example, the first door 30A may include the first touch sensor 200A mounted on the lower cap 36 of the first door 30A. The first touch sensor 200A may be mounted on the lower portion of the lower cap 36 of the first door 30A. In addition, for example, the second door 30B may include the second touch sensor 200B mounted on the lower cap 36 of the second door 30B. The second touch sensor 200B may be mounted on the lower cap 36 of the second door 30B. The second touch sensor 200B may be mounted on the lower portion of the lower cap 36 of the second door 30B.

The first touch sensor 200A and the second touch sensor 200B may be disposed at a height corresponding to each other. The first touch sensor 200A and the second touch sensor 200B may be disposed side by side to each other in the horizontal direction.

As shown in FIG. 7, the first touch sensor 200A and the second touch sensor 200B may each be disposed adjacent to a central portion of the refrigerator 1. In other words, the sensor mounting portion 36b formed in the lower cap 36 of the first door 30A and the sensor mounting portion 36b formed in the lower cap 36 of the second door 30B may each be disposed adjacent to a central portion of the refrigerator 1. The first touch sensor 200A may be disposed adjacent to the right end of the first door 30A. In the first door 30A, the sensor mounting portion 36b may be formed at a position adjacent to a right end of the lower cap 36. The second touch sensor 200B may be disposed adjacent to the left end of the second door 30B. In the second door 30B, the sensor mounting portion 36b may be formed adjacent to a left end of the lower cap 36. Since the right end of the first door 30A is farther from the rotation axis of the first door 30A than the left end, a typical user may have a tendency to grip a portion adjacent to the right end of the first door 30A in order to open the first door 30A with less force. Similarly, since the left end of the second door 30B is farther from the rotation axis of the second door 30B than the right end, a typical user may have a tendency to grip a portion adjacent to the left end of the second door 30B in order to open the second door 30B with less force. Accordingly, the first touch sensor 200A and the second touch sensor 200B may each be disposed adjacent to the central portion of the refrigerator 1, so that the touch signal of the user may be received more efficiently.

The first touch sensor 200A may be positioned above the third door 30C, which is a lower door positioned below the first door 30A. In this case, the first touch sensor 200A may be disposed to be spaced apart from an upper end of the third door 30C so as not to interfere with the third door 30C. A lower end of the first touch sensor 200A may be disposed to be spaced apart from the upper end of the third door 30C. The front touch portion 210b and the bottom touch portion 210a of the first touch sensor 200A may be disposed to be spaced apart from the upper end of the third door 30C. Accordingly, the first touch sensor 200A may not be interfered with by the third door 30C, and the first touch sensor 200A may be prevented from erroneously detecting a signal by the third door 30C.

The second touch sensor 200B may be positioned above the fourth door 30D, which is a lower door positioned below the second door 30B. In this case, the second touch sensor 200B may be disposed to be spaced apart from an upper end of the fourth door 30D so as not to interfere with the fourth door 30D. A lower end of the second touch sensor 200B may be disposed to be spaced apart from the upper end of the fourth door 30D. The front touch portion 210b and the bottom touch portion 210a of the second touch sensor 200B may be disposed to be spaced apart from the upper end of the fourth door 30D. Accordingly, the second touch sensor 200B may not be interfered with by the fourth door 30D, and the second touch sensor 200B may be prevented from erroneously detecting a signal by the fourth door 30D.

In an embodiment, the front end 36c of the lower cap 36 may be seated on a portion of an upper surface of the sensor case 210 of the touch sensor 200. The sensor case 210 may include a stepped portion 212bb formed to be stepped such that the front end 36c of the lower cap 36 is seated. The front end 36c of the lower cap 36 may contact the stepped portion 212bb.

The stepped portion 212bb may be formed at a front end portion of the sensor case 210. The stepped portion 212bb may have a stepped shape such that an upper surface of a portion of the front end portion of the sensor case 210 is positioned lower than an upper surface of other portions. As shown in FIG. 10, a portion having a lower upper surface may be located further forward than the other portions. With such a shape, the stepped portion 212bb may contact a lower surface and a rear surface of the front end 36c of the lower cap 36, respectively, and the front end 36c of the lower cap 36 may be seated on the stepped portion 212bb.

In an example embodiment, the front touch portion 210b may be provided at a lower side of the stepped portion 212bb. The front touch portion 210b may extend downwardly from the stepped portion 212bb.

In an example embodiment, the front end 36c of the lower cap 36 may form a front side border of the front sensor groove 36bb. The stepped portion 212bb may be a portion inserted into the front sensor groove 36bb of the sensor case 210.

As such, as the sensor case 210 includes the stepped portion 212bb, the sensor case 210 may be stably supported on the lower cap 36 by contacting the front end 36c of the lower cap 36, with a portion thereof inserted into the sensor mounting portion 36b to reduce a degree of protrusion downward from the lower cap 36. The sensor case 210 may include the stepped portion 212bb to be stably mounted to the lower cap 36 while reducing a degree of protrusion downward from the lower cap 36, thereby preventing interference with an upper end of the lower door. In other words, such a structure may allow the touch sensor 200 provided at the lower portion of the upper door to be prevented from interfering with the upper end of the lower door.

In an example embodiment, the stepped portion 212bb may be formed in a second case front portion 212b of a second sensor case 212, which will be described later, but is not limited thereto.

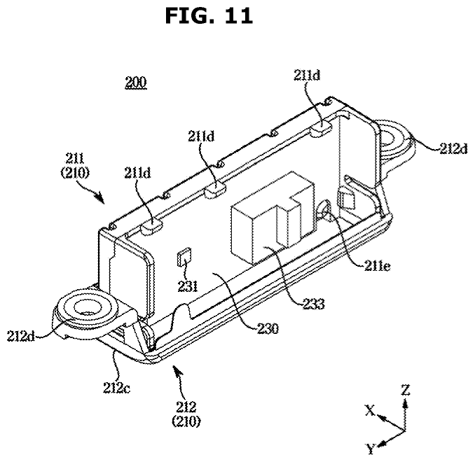

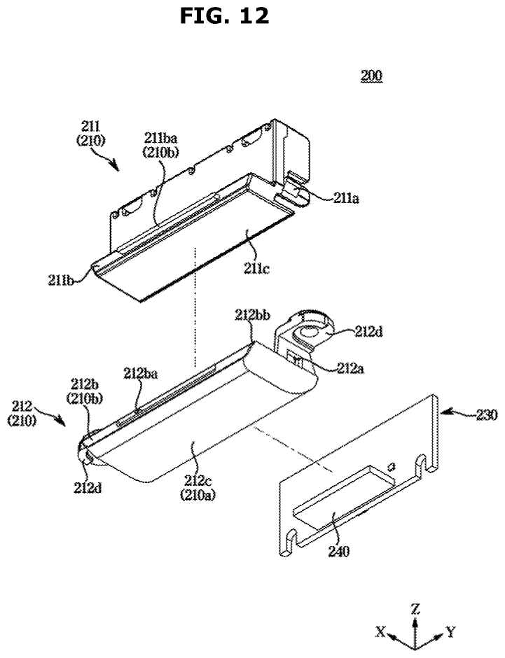

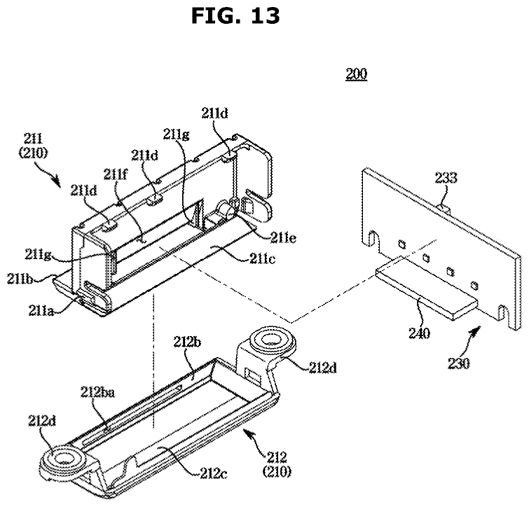

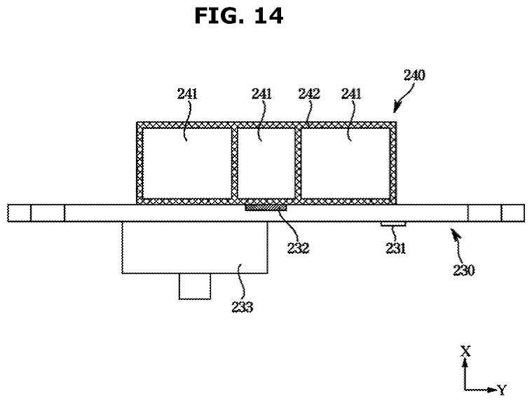

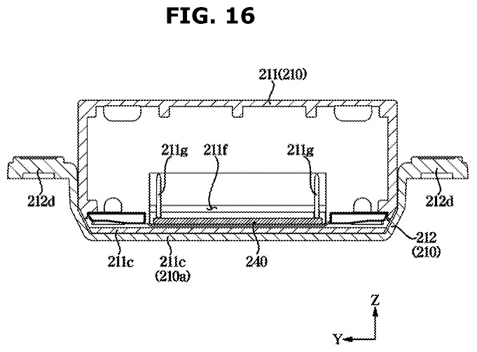

FIG. 11 is a rear perspective view illustrating a touch sensor of a refrigerator according to an embodiment of the present disclosure. FIG. 12 is an exploded view of the touch sensor of the refrigerator according to an embodiment of the present disclosure. FIG. 13 is an exploded view of the touch sensor of the refrigerator according to an embodiment of the present disclosure. FIG. 14 is a view illustrating a printed circuit board and a signal conductor of the touch sensor of the refrigerator according to an embodiment of the present disclosure, viewed from below. FIG. 15 is a cross-sectional view illustrating some configurations of a door, such as a door panel, a lower cap, and a touch sensor, of a refrigerator, which are cut away, according to an embodiment of the present disclosure. FIG. 16 is a cross-sectional view illustrating a touch sensor of a refrigerator, which is cut away, according to an embodiment of the present disclosure from below.

Referring to FIGS. 11 to 16, a touch sensor 200 of the refrigerator 1 according to an embodiment of the present disclosure may include the sensor case 210 and a printed circuit board 230 accommodated in the sensor case 210 and on which electronic components are mounted.

The printed circuit board 230 may include circuitry capable of detecting a change in capacitance. For example, a sensor chip 231 may be mounted on the printed circuit board 230. The sensor chip 231 may be configured to detect a touch signal based on a change in capacitance. In an example embodiment, the sensor chip 231 may include an integrated circuit (IC).

The printed circuit board 230 may be electrically connected to a controller, a power supply, and the like, disposed on a side of the main body 10 by wires (not shown) passing through the upper cap 35 or the lower cap 36. A socket 233 to which wires are connected may be mounted on the printed circuit board 230 such that the sensor chip 231 may be electrically connected to the controller, the power supply, and the like, through the wires. In an example embodiment, the wire connected to the socket 233 may be connected to the controller to transmit a signal output from the sensor chip 231 to the controller. In an example embodiment, the wire connected to the socket 233 may be connected to a power supply to apply power to the printed circuit board 230. In an example embodiment, the wire connected to the socket 233 may be connected to a ground. Alternatively, In an example embodiment, the printed circuit board 230 may be wirelessly connected to the controller, or the like, disposed on a side of the main body 10.

The touch sensor 200 may include a signal conductor 240 configured to transmit a touch signal to the printed circuit board 230. The signal conductor 240 may be mounted to the printed circuit board 230. The signal conductor 240 may be configured to transmit a touch signal input from the bottom touch portion 210a or the front touch portion 210b to the printed circuit board 230.

For example, the signal conductor 240 may include a conductive material, and may be connected to an electrode 232 mounted on the printed circuit board 230 to transmit a touch signal to the sensor chip 231 through the electrode 232.

The signal conductor 240 may include a conductive layer 242 provided along a border of the signal conductor 240. The conductive layer 242 may include a conductive material. The conductive layer 242 may be attached to the electrode 232 and configured to transmit a touch signal to the electrode 232. In an example embodiment, the conductive layer 242 may include a conductive tape having electrical conductivity, and the signal conductor 240 may be attached to the electrode 232 and one surface of the printed circuit board 230 on which the electrode 232 is disposed by the conductive layer 242.

The signal conductor 240 may be configured to be elastically deformable. By being elastically deformable, the signal conductor 240 may be easily inserted into a signal conductor receiving groove 211f of a first sensor case 211, which will be described later, and may be pressed tightly against a first case front portion 211b by a retaining rib 211g.

In an example embodiment, the signal conductor 240 may include an elastically deformable elastic member 241. The conductive layer 242 may enclose the elastic member 241.

The signal conductor 240 may include various types of touch gaskets known in the art.

The sensor case 210 of the touch sensor 200 may support the printed circuit board 230 and the signal conductor 240. The sensor case 210 may accommodate the printed circuit board 230 and the signal conductor 240.

The sensor case 210 may include the first sensor case 211 and the second sensor case 212. The second sensor case 212 may be disposed below the first sensor case 211. The second sensor case 212 may cover a lower portion of the first sensor case 211. The second sensor case 212 may support the first sensor case 211 from below.

The first sensor case 211 may include the first case front portion 211b forming a front surface of the first sensor case 211. The first case front portion 211b may cover a front surface of the signal conductor 240. In an example embodiment, the first case front portion 211b may be provided in front of the signal conductor receiving groove 211f, which will be described later. The first case front portion 211b may form a front surface of the signal conductor receiving groove 211f, which will be described later.

In an example embodiment, the first case front portion 211b may include a touch protrusion 211ba. The touch protrusion 211ba may be formed to protrude forwardly through the second sensor case 212. The touch protrusion 211ba may be provided to allow a user to touch the touch sensor 200 from the front surface. The touch protrusion 211ba may be disposed in front of the signal conductor 240. The touch protrusion 211ba may be formed in front of the signal conductor receiving groove 211f, which will be described later. Accordingly, the signal conductor 240 may more efficiently transmit a touch signal from the front to the printed circuit board 230.

The first sensor case 211 may include a first base 211c forming a lower surface of the first sensor case 211. The first base 211c may cover a lower side of the signal conductor 240. The first base 211c may support the signal conductor 240 from below. The first base 211c may contact a lower surface of the signal conductor 240. In an example embodiment, the first base 211c may be provided below the signal conductor receiving groove 211f, which will be described later. The first base 211c may form a lower surface of the signal conductor receiving groove 211f, which will be described later.

The second sensor case 212 may include the second case front portion 212b forming a front surface of the second sensor case 212. The second case front portion 212b may be disposed in front of the signal conductor 240. The second case front portion 212b may be disposed in front of the first case front portion 211b. The second case front portion 212b may cover the first case front portion 211b from the front.

The second case front portion 212b may form the front surface of the sensor case 210. That is, the second case front portion 212b may form the front surface of the touch sensor 200.

In an example embodiment, the second case front portion 212b may include a protrusion hole 212ba formed for the touch protrusion 211ba to pass through. The touch protrusion 211ba may be exposed forwardly by a protrusion hole 212ba. Accordingly, the touch protrusion 211ba may form a portion of the front surface of the sensor case 210. In other words, the touch protrusion 211ba may form a portion of the front surface of the touch sensor 200.

The second sensor case 212 may include a second base 212c forming a lower surface of the second sensor case 212. The second base 212c may be disposed below the signal conductor 240. The second base 212c may cover a lower side of the first sensor case 211. The second base 212c may cover a lower side of the first base 211c. The first base 211c may be seated on the second base 212c, and the second base 212c may support the first base 211c.

The second base 212c may form the lower surface of the sensor case 210. In other words, the second base 212c may form the lower surface of the touch sensor 200.

In an example embodiment, the first sensor case 211 may include a plastic material. In an example embodiment, the second sensor case 212 may include a plastic material. However, the present disclosure is not limited thereto, and the first sensor case 211 and the second sensor case 212 may each include a variety of materials.

In an example embodiment, the first sensor case 211 and the second sensor case 212 may be formed as separate configurations and coupled together. The first sensor case 211 may include a first case coupling portion 211a, and the second sensor case 212 may include a second case coupling portion 212a, and the first sensor case 211 and the second sensor case 212 may be coupled to each other by coupling the first case coupling portion 211a and the second case coupling portion 212a. As shown in FIGS. 12 and 13, the second case coupling portion 212a may have the shape of a hole, and the first case coupling portion 211a may have the shape of a protrusion that snap-fits into the hole, but a coupling structure of the first sensor case 211 and the second sensor case 212 is not limited thereto.

Alternatively, In an example embodiment, the first sensor case 211 and the second sensor case 212 may be integrally formed.

The first sensor case 211 and the second sensor case 212 may be mounted to the sensor mounting portion 36b in a state of being coupled to each other, or as one piece. At least a portion of the first sensor case 211 may be inserted into the sensor mounting portion 36b. At least a portion of the second sensor case 212 may be inserted into the sensor mounting portion 36b.

The door mounting portion 212d described above may be provided in the second sensor case 212, for example. Since the second sensor case 212 is disposed on the lower side of the first sensor case 211, the first sensor case 211 and the second sensor case 212 may be more firmly mounted to the lower cap 36 by the fastening member F that penetrates and fastens the door mounting portion 212d and the lower cap 36 from bottom to top. However, the present disclosure is not limited thereto, and the first sensor case 211 may also be provided with a structure coupled to the lower cap 36.

A space in which the printed circuit board 230 and the signal conductor 240 are accommodated may be formed inside the sensor case 210. The sensor case 210 may include substrate fixing portions 211d, 211e configured to secure the printed circuit board 230. For example, the sensor case 210 may include a first substrate fixing portion 211d supporting an upper portion of the printed circuit board 230 and a second substrate fixing portion 211e supporting a lower portion of the printed circuit board 230, and the printed circuit board 230 may be secured to the sensor case 210 by being supported at the upper portion and the lower portion by the first substrate fixing portion 211d and the second substrate fixing portion 211e. In an example embodiment, the first substrate fixing portion 211d may be provided on an upper portion of the first sensor case 211. In an example embodiment, the second substrate fixing portion 211e may be provided on a lower portion of the first sensor case 211. However, the present disclosure is not limited thereto, and the sensor case 210 may include various structures for securing the printed circuit board 230.

The sensor case 210 may include the signal conductor receiving groove 211f accommodating the signal conductor 240. The signal conductor 240 may be inserted into the signal conductor receiving groove 211f. The signal conductor receiving groove 211f may be formed adjacent to a front portion of the sensor case 210 such that the signal conductor 240 may efficiently transmit touch signals from the front to the printed circuit board 230. The printed circuit board 230 coupled to the signal conductor 240 may be disposed on a rear side of the signal conductor receiving groove 211f. For example, the signal conductor 240 may be inserted into the signal conductor receiving groove 211f from the rear to the front.

In an example embodiment, the signal conductor receiving groove 211f may be formed inside the first sensor case 211. The first case front portion 211b may be provided in front of the signal conductor receiving groove 211f. The first base 211c may be provided below the signal conductor receiving groove 211f.

The configurations of the sensor case 210, including the first sensor case 211 and the second sensor case 212, and the like, are not limited to those described above, and the sensor case 210 may include various configurations to support the printed circuit board 230 and the signal conductor 240, and to be mounted to the lower cap 36.

As described above, the touch sensor 200 may receive a touch signal TS1 from a lower side of the touch sensor 200 or a touch signal TS2 from a front side of the touch sensor 200.

When a user touches the bottom touch portion 210a, the touch signal TS1 input to the bottom touch portion 210a may be transmitted to the printed circuit board 230 through the signal conductor 240. For example, the bottom touch portion 210a may cover the lower side of the signal conductor 240. The bottom touch portion 210a may be disposed below the signal conductor 240. The bottom touch portion 210a may be disposed below the signal conductor receiving groove 211f. In an example embodiment, the bottom touch portion 210a and the signal conductor 240 may be disposed parallel to each other in the vertical direction (Z).

In an example embodiment, the bottom touch portion 210a may be provided on the second base 212c described above. In other words, when a user touches the second base 212c, the touch signal TS1 caused by a change in capacitance at the lower side may be transmitted to the printed circuit board 230 via the signal conductor 240.

To efficiently receive the touch signal TS1 from the lower side, the bottom touch portion 210a may be positioned lower than the sensor mounting portion 36b. For example, the bottom touch portion 210a may be positioned below an opening 36ba of the sensor mounting portion 36b. In addition, the signal conductor 240 may be positioned below the sensor mounting portion 36b.

When a user touches the front touch portion 210b, the touch signal TS2 input to the front touch portion 210b may be transmitted to the printed circuit board 230 via the signal conductor 240. For example, the front touch portion 210b may cover a front side of the signal conductor 240. The front touch portion 210b may be disposed in front of the signal conductor 240. The front touch portion 210b may be disposed in front of the signal conductor receiving groove 211f. In an example embodiment, the front touch portion 210b and the signal conductor 240 may be disposed parallel to each other in the front-to-back direction (X).

In an example embodiment, the front touch portion 210b may be formed by the second case front portion 212b and the touch protrusion 211ba described above. In other words, when a user touches the second case front portion 212b or the touch protrusion 211ba, the touch signal TS2 caused by a change in capacitance at the front side may be transmitted to the printed circuit board 230 via the signal conductor 240.

To efficiently receive the touch signal TS2 from the front side, the front touch portion 210b may be positioned below the sensor mounting portion 36b. For example, the front touch portion 210b may be positioned below the opening 36ba of the sensor mounting portion 36b. Further, the front touch portion 210b may be positioned below the lower end of the door panel 31 and the front lower end of the lower cap 36.

Furthermore, to efficiently receive the touch signal TS2 from the front side, the signal conductor 240 may be positioned below the sensor mounting portion 36b as described above. The signal conductor 240 may be positioned below the lower end of the sensor mounting portion 36b. In particular, the signal conductor 240 may be positioned below the opening 36ba of the sensor mounting portion 36b. In addition, the signal conductor 240 may be positioned below the lower end of the door panel 31. In addition, the signal conductor 240 may be positioned below the front lower end of the lower cap 36. In other words, the signal conductor 240 may be located outside below the sensor mounting portion 36b. By such a configuration, the signal conductor 240 may be aligned with the front touch portion 210b in the front-to-back direction (X) to efficiently transmit the touch signal TS2 input through the front touch portion 210b to the printed circuit board 230.

In addition, to efficiently receive the touch signal TS2 from the front side, the signal conductor 240 may extend from the printed circuit board 230 toward the front touch portion 210b. In other words, the signal conductor 240 may extend forward from the printed circuit board 230 toward the front touch portion 210b. The signal conductor 240 may extend in the front-to-back direction (X) within the signal conductor receiving groove 211f.

With such a configuration, the touch sensor 200 may receive the touch signals from at least two or more directions, such as the touch signal TS1 from the lower side or the touch signal TS2 from the front side. Thereby, the touch sensor 200 may receive touch signals more efficiently, and user convenience may be improved.

The sensor case 210 may include the retaining rib 211g to retain the signal conductor 240. The retaining rib 211g may press against the signal conductor 240 to secure the signal conductor 240. The retaining rib 211g may secure the signal conductor 240 to the sensor case 210.

[symbol] , the retaining rib 211g may secure the signal conductor 240 by pressing the signal conductor 240 from an upper side to a lower side of the signal conductor 240. The retaining rib 211g may secure the signal conductor 240 by pressing the signal conductor 240 to the bottom touch portion 210a.

In an example embodiment, as described above, the signal conductor 240 may be provided to be elastically deformable, and when inserted into the signal conductor receiving groove 211f, the signal conductor 240 may be secured to the sensor case 210 by being sandwiched between the retaining rib 211g and the first base 211c.

In an example embodiment, the retaining rib 211g may be provided inside the signal conductor receiving groove 211f. In an example embodiment, the retaining rib 211g may have a shape protruding downwardly from an inner surface of the first sensor case 211.

In an example embodiment, the retaining rib 211g may be provided in a plurality. While FIG. 16 shows an embodiment in which the retaining ribs 211g are provided in pairs, the number of retaining ribs 211g that may be provided on the sensor case 210 is not limited thereto.

By pressing and securing the signal conductor 240 to the bottom touch portion 210a, the retaining ribs 211g may prevent the signal conductor 240 from moving within the sensor case 210, and may maintain a constant distance between the signal conductor 240 and the bottom touch portion 210a. Further, the retaining ribs 211g may reduce a gap (e.g., an air gap) between the signal conductor 240 and the first base 211c by pressing the signal conductor 240 downwardly.

As such, the sensor case 210 may retain the signal conductor 240 using the retaining ribs 211g, which may improve the precision and accuracy of touch signal input.

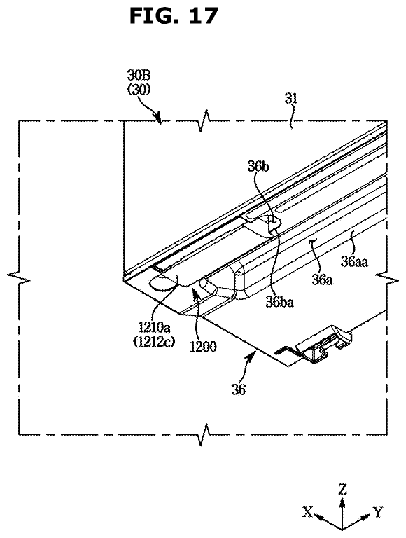

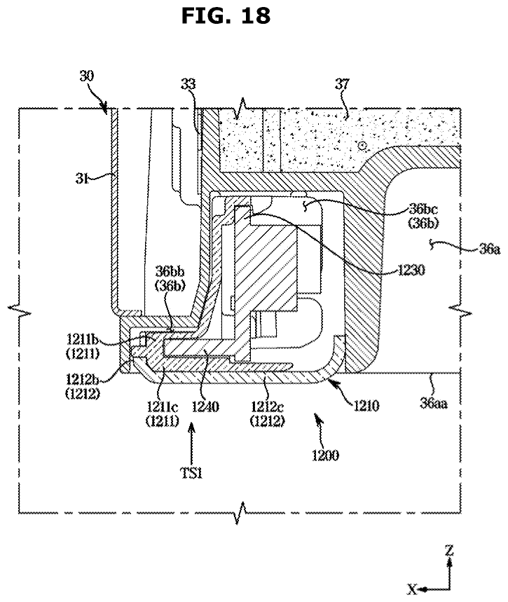

FIG. 17 is a view illustrating some configurations of a door, such as a door panel, a lower cap, and a touch sensor, of a refrigerator according to an embodiment of the present disclosure from below. FIG. 18 is a cross-sectional view illustrating some configurations of the door, such as a door panel, a lower cap, and a touch sensor, of the refrigerator, which are cut away, according to an embodiment of the present disclosure.

In describing the configurations of a refrigerator according to an embodiment of the present disclosure with reference to FIGS. 17 and 18, the same reference numerals may be assigned to the same configurations as the embodiment shown in FIGS. 1 to 16, and description thereof may be omitted.

Referring to FIGS. 17 and 18, the door 30 of the refrigerator 1 according to an embodiment of the present disclosure may include a touch sensor 1200 configured to receive the touch signal TS1 for opening the door opening device 100 from a lower side. In contrast to the touch sensor 200 of the embodiment of FIGS. 1 to 16, the touch sensor 1200 of FIGS. 17 and 18 may be configured not to receive a touch signal from the front side.

The touch sensor 1200 may include a printed circuit board 1230, a signal conductor 1240 mounted on the printed circuit board 1230 and configured to transmit a touch signal to the printed circuit board 1230, and a sensor case 1210 supporting the printed circuit board 1230 and the signal conductor 1240. In an example embodiment, the sensor case 1210 may include a first sensor case 1211 and a second sensor case 1212. A detailed description of the configurations of the touch sensor 1200, such as the printed circuit board 1230, the signal conductor 1240, and the sensor case 1210, will be omitted.

The touch sensor 1200 may be mounted to the lower cap 36 of the door 30. The touch sensor 1200 may be mounted to the sensor mounting portion 36b. The sensor mounting portion 36b may be formed in front of a handle 36a, and the touch sensor 1200 may be disposed in front of the handle 36a.

The touch sensor 1200 may be inserted into and mounted to the sensor mounting portion 36b. The touch sensor 1200 may be inserted into and mounted to the sensor mounting portion 36b through the opening 36ba. The sensor case 1210 may be inserted into and mounted to the sensor mounting portion 36b.

The touch sensor 1200 may include a bottom touch portion 1210a configured to receive the touch signal TS1 from a lower side of the touch sensor 1200. The bottom touch portion 1210a may be provided on a lower surface of the touch sensor 1200. The bottom touch portion 1210a may be provided on a lower surface of the sensor case 1210. The bottom touch portion 1210a may be exposed downwardly to allow a user to touch from below. When the user touches the bottom touch portion 1210a, the touch sensor 1200 may receive a touch signal from the lower side. The bottom touch portion 1210a may cover a lower side of the signal conductor 1240. The signal conductor 1240 may transmit a touch signal input from the bottom touch portion 1210a to the printed circuit board 1230. In an example embodiment, the bottom touch portion 1210a may be provided on a second base 1212c forming a lower surface of the second sensor case 1212.

The signal conductor 1240 may be accommodated in a signal conductor receiving groove formed inside the first sensor case 1211. The signal conductor 1240 may be supported by a first base 1211c of the first sensor case 1211.

The first sensor case 1240 may include a retaining rib to retain the signal conductor 1240, and the retaining rib may press the signal conductor 1240 toward the bottom touch portion 1210a from an upper side of the signal conductor 1240. In an example embodiment, the retaining rib may be disposed within the signal conductor receiving groove.

The bottom touch portion 1210a of the touch sensor 1200 mounted on the upper door may be disposed to be spaced apart from the upper end of the lower door. Thereby, the touch sensor 1200 may not be interfered with by the lower door, and may be prevented from erroneously detecting a signal by the lower door.

The touch sensor 1200 of FIGS. 17 and 18 may protrude downwardly from the sensor mounting portion 36b by a smaller amount than the touch sensor 200 of FIGS. 1 to 16 protrudes downwardly from the sensor mounting portion 36b. The touch sensor 1200 may be inserted almost entirely within the sensor mounting portion 36b. The sensor case 1210 may be inserted almost entirely within the sensor mounting portion 36b. As a result, the touch sensor 1200 may be more efficiently prevented from interfering with the lower door adjacent thereto, and the touch sensor 1200 may be more efficiently prevented from erroneously detecting a signal.

As such, to reduce a degree of protruding downwardly from the sensor mounting portion 36b while the touch sensor 1200 is configured to receive a touch signal from the lower side of the touch sensor 1200, the bottom touch portion 1210a may be disposed at substantially the same height as the lower end of the sensor mounting portion 36b. For example, the bottom touch portion 1210a may be disposed in the opening 36ba of the sensor mounting portion 36b.

In addition, the signal conductor 1240 may be positioned inside the sensor mounting portion 36b. The signal conductor 1240 may be disposed at substantially the same height as or higher than the lower end of the sensor mounting portion 36b. The signal conductor 1240 may be positioned at substantially the same height as or higher than the opening 36ba of the sensor mounting portion 36b.

In addition, at least a majority of a front surface of the sensor case 1210, which is disposed in front of the signal conductor 1240, may be inserted into the sensor mounting portion 36b. At least a majority of the front surface of the sensor case 1210 may be disposed flush with or above the opening 36ba of the sensor mounting portion 36b. The front surface of the sensor case 1210 may be covered by the lower cap 36. For example, a front end of the lower cap 36 may be positioned in front of a first case front portion 1211b of the first sensor case 1211 and a second case front portion 1212b of the second sensor case 1212.

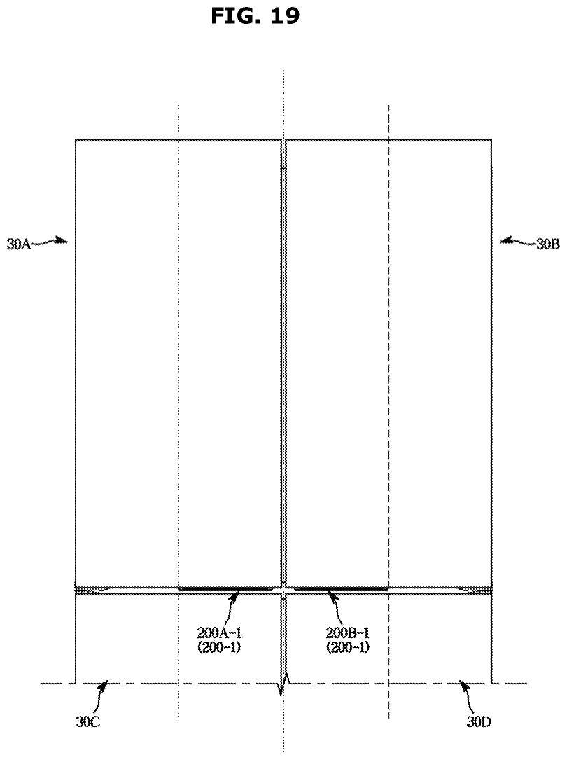

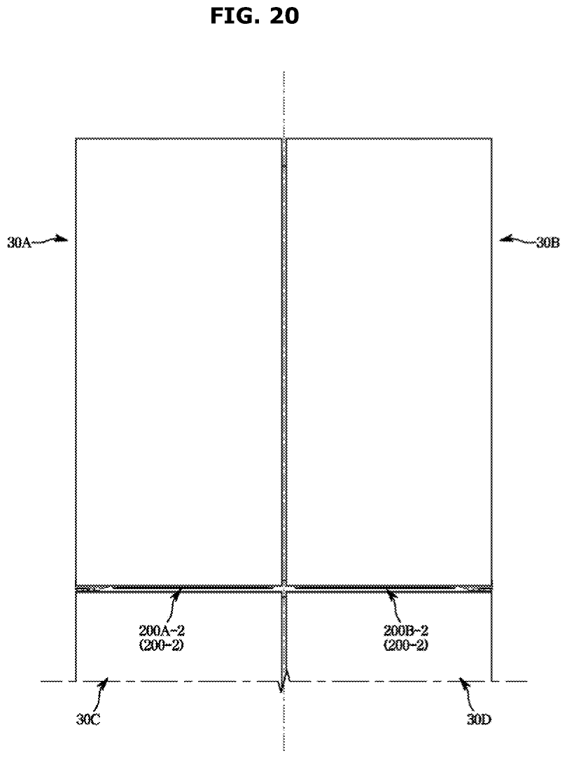

FIG. 19 is an enlarged view of a state in which an upper door of a refrigerator is closed, according to an embodiment of the present disclosure. FIG. 20 is an enlarged view of a state in which an upper door of a refrigerator is closed, according to an embodiment of the present disclosure.

In describing the configurations of a refrigerator according to an embodiment of the present disclosure with reference to FIGS. 19 and 20, the same reference numerals may be assigned to the same configurations as the embodiment shown in FIGS. 1 to 18, and further description thereof may be omitted.

Referring to FIG. 19, a touch sensor 200-1 of the refrigerator 1 according to an embodiment of the present disclosure may extend from a first side adjacent to a central portion of the refrigerator 1 to a second side located at a central portion of the door 30.

For example, a first touch sensor 200A-1 provided on the first door 30A may extend in the horizontal direction (Y) from a first side adjacent to the right end of the first door 30A to a second side located at a central portion of the first door 30A. The right end of the first door 30A may be one end that is distal in the horizontal direction (Y) from the rotation axis of the first door 30A.

In addition, for example, a second touch sensor 200B-1 provided on the second door 30B may extend in the horizontal direction (Y) from a first side adjacent to the left end of the second door 30B to a second side located at a central portion of the second door 30B. The left end of the second door 30B may be one end that is distal in the horizontal direction (Y) from the rotation axis of the second door 30B.

Referring to FIG. 20, a touch sensor 200-2 of a refrigerator 1 according to an embodiment of the present disclosure may extend from a first side adjacent to a central portion of the refrigerator 1 to a second side adjacent to a rotation axis of the door 30.

For example, a first touch sensor 200A-2 provided on the first door 30A may extend from a first side adjacent to the right end of the first door 30A to a second side adjacent to the left end of the first door 30A. A distance between the second side adjacent to the left end of the first door 30A of the first touch sensor 200A-2 and the left end of the first door 30A may be shorter than a distance between the left end of the first door 30A and the central portion of the first door 30A. In other words, the first touch sensor 200A-2 may be disposed across substantially the entire area of the lower portion of the first door 30A in the horizontal direction.

In addition, for example, a second touch sensor 200B-2 provided on the second door 30B may extend from a first side adjacent to the left end of the second door 30B to a second side adjacent to the right end of the second door 30B. A distance between the second side adjacent to the right end of the second door 30B of the second touch sensor 200B-2 and the right end of the second door 30B may be shorter than a distance between the right end of the second door 30B and the central portion of the second door 30B. In other words, the second touch sensor 200B-2 may be disposed across substantially the entire area of the lower portion of the second door 30B in the horizontal direction.

According to an embodiment in FIG. 19 or FIG. 20, by increasing the area over which the touch sensor 200-1 or 200-2 may receive touch signals, the touch sensor may receive touch signals more efficiently.

While FIGS. 19 and 20 illustrate an embodiment of the touch sensors 200-1 and 200-2 that includes both a front touch portion and a bottom touch portion, such as the touch sensor 200 described with reference to FIGS. 1 to 16, respectively, the present disclosure is not limited thereto, and the content described with reference to FIGS. 19 and 20 may be equally applicable to an embodiment of the touch sensor that includes only a bottom touch portion without a front touch portion, such as the touch sensor 1200 of FIGS. 17 and 18.

On the other hand, unlike what has been described with reference to FIGS. 1 to 20, a refrigerator according to an embodiment may include only one door opening device configured to open only one door, and a touch sensor may also be provided on only one door, and the configurations of the present disclosure may be equally applicable to such embodiments.

The refrigerator according to an embodiment of the present disclosure may include the main body 10 defining the storage compartment 20, the door 30 configured to open or close at least a portion of the storage compartment, and the door opening device 100 configured to open the door. The door may include the door panel 31 defining a surface of the door, the lower cap 36 on a lower side of the door panel and including the handle 36a and the sensor mounting portion 36b in front of the handle, and the touch sensor 200 on the sensor mounting portion and configured to receive a touch signal to operate the door opening device. The touch sensor may include the bottom touch portion 210a below the sensor mounting portion and configured to receive a touch signal from a lower side of the touch sensor, and the front touch portion 210b below the sensor mounting portion, in front of the bottom touch portion, and configured to receive a touch signal from a front side of the touch sensor.

The front touch portion 210b may be below a front lower end of the lower cap 36.

The touch sensor may further include the printed circuit board 230, and the signal conductor 240 on the printed circuit board and configured to transmit a touch signal to the printed circuit board. The bottom touch portion 210a may cover a lower side of the signal conductor 240. The front touch portion 210b may cover a front of the signal conductor 240.

The signal conductor 240 may be below the sensor mounting portion 36b.

The signal conductor 240 may be below a front lower end of the lower cap 36.

The signal conductor 240 may extend from the printed circuit board 230 toward the front touch portion 210b.

The touch sensor may include the sensor case 210 coupled to the sensor mounting portion 36b and supporting the printed circuit board 230 and the signal conductor 240. The bottom touch portion 210a may be on a lower surface of the sensor case, and the front touch portion 210b may be on a front surface of the sensor case.

The sensor case may include the retaining rib 211g configured to press the signal conductor 240 toward the bottom touch portion 210a from an upper side of the signal conductor 240 to secure the signal conductor 240.

The signal conductor 240 may include a conductive material, and may be configured to be elastically deformable.

The touch sensor may include the sensor case 210 on the sensor mounting portion. The sensor case may include the stepped portion 212bb stepped such that the front end 36c of the lower cap 36 is seated. The stepped portion may contact a lower surface and a rear surface of the front end of the lower cap.

The front touch portion 210b may extend downwardly from the stepped portion 212bb.

The touch sensor may include the sensor case 210. The sensor mounting portion 36b may be formed by recessing upwardly from the opening 36ba on a lower surface of the lower cap such that a first portion of the sensor case is inserted. A second portion of the sensor case may protrude to an outside of the sensor mounting portion through the opening of the sensor mounting portion.

The bottom touch portion 210a may be on a lower surface of the sensor case on a lower side of the opening. The front touch portion 210b may be on a front surface of the sensor case on the lower side of the opening.

An upper portion of the sensor case may be in the sensor mounting portion and coupled to the lower cap.

The door may be an upper door, and the refrigerator may further include a lower door below the upper door and arranged parallel to the upper door in a vertical direction. An upper end of the lower door may be spaced apart from the front touch portion and the bottom touch portion.

The refrigerator according to an embodiment of the present disclosure may include the main body 10 forming the storage compartment 20, the door 30 configured to open or close at least a portion of the storage compartment, and the door opening device 100 configured to open the door. The door may include the lower cap 36 on a first portion of the door and including the handle 36a and the sensor mounting portion 36b in front of the handle, and the touch sensor 200 coupled to the sensor mounting portion and configured to receive a touch signal to operate the door opening device. The touch sensor may include the printed circuit board 230, and the signal conductor 240 mounted on the printed circuit board, configured to transmit a touch signal to the printed circuit board, and below the sensor mounting portion 36b.

The touch sensor may further include the sensor case 210 coupled to the sensor mounting portion 36b and supporting the printed circuit board and the signal conductor 240. The sensor case may include the bottom touch portion 210a covering the signal conductor 240 from a first direction, and the front touch portion 210b positioned below the sensor mounting portion 36b and covering the signal conductor 240 from a second direction. The signal conductor 240 may be configured to transmit a touch signal input from the bottom touch portion 210a side or a touch signal input from the front touch portion 210b side to the printed circuit board.

The refrigerator according to an embodiment of the present disclosure may include the main body 10 forming the storage compartment 20, the door 30 configured to open or close at least a portion of the storage compartment, and the door opening device 100 configured to open the door. The door may include the door panel 31 defining a surface of the door, the lower cap 36 on a first side of the door panel and including the handle 36a and the sensor mounting portion 36b in front of the handle and recessed upwardly from the opening 36ba, and the touch sensor 1200 in the sensor mounting portion 36b and configured to receive a touch signal to operate the door opening device. The touch sensor may include the bottom touch portion 1210a in the opening 36ba of the sensor mounting portion 36b and configured to receive a touch signal from a first side of the touch sensor.

The touch sensor may further include the printed circuit board 1230, and the signal conductor 1240 on the printed circuit board, configured to transmit a touch signal input from the bottom touch portion 1210a side to the printed circuit board, and positioned above the opening 36ba of the sensor mounting portion 36b. The bottom touch portion 1210a may cover a first side of the signal conductor.

The touch sensor may include the sensor case 1210 in the sensor mounting portion. The bottom touch portion may be provided on a first surface of the sensor case. A second surface of the sensor case may be covered by the lower cap.

According to an embodiment the present disclosure, the door may include a touch sensor to receive a touch signal to operate the door opening device.

According to an embodiment the present disclosure, the touch sensor may be disposed in front of the handle of the door to efficiently receive a touch signal from a user, thereby improving user convenience.

According to an embodiment the present disclosure, the touch sensor may be arranged to protrude downwardly from the lower cap to receive a touch signal from a lower side or a front side.

According to an embodiment the present disclosure, the touch sensor may include a retaining rib that presses the signal conductor downward to secure the signal conductor, thereby improving the precision and accuracy of touch signal input.

According to an embodiment the present disclosure, the touch sensor may be mounted to the lower cap so as to protrude downwardly by a short length, thereby preventing the touch sensor from interfering with the adjacent door and preventing a touch sensor from erroneously detecting a signal.

According to an embodiment the present disclosure, the touch sensor may be inserted into and mounted to the sensor mounting portion of the lower cap, and the bottom touch portion configured to receive a touch signal from a lower side may be disposed in the opening of the sensor mounting portion, thereby preventing the touch sensor from interfering with the adjacent door and preventing the touch sensor from erroneously detecting a signal.

The effects to be obtained from the present disclosure are not limited to the effects mentioned above, and other unmentioned effects may be clearly understood by those of ordinary skill in the art to which the present disclosure pertains from the description below.

While the present disclosure has been particularly described with reference to exemplary embodiments, it should be understood by those of skilled in the art that various changes in form and details may be made without departing from the spirit and scope of the present disclosure.

What is claimed is:

1. A refrigerator, comprising:
a main body defining a storage compartment;
a door configured to open or close at least a portion of the storage compartment; and
a door opening device configured to open the door,
wherein the door comprises:
a door panel defining a surface of the door;
a lower cap on a lower side of the door panel, and comprising a handle and a sensor mounting portion in front of the handle; and
a touch sensor on the sensor mounting portion and configured to receive a touch signal to operate the door opening device, and
wherein the touch sensor comprises:
a bottom touch portion below the sensor mounting portion and configured to receive a touch signal from a lower side of the touch sensor; and
a front touch portion below the sensor mounting portion, in front of the bottom touch portion, and configured to receive a touch signal from a front side of the touch sensor.

2. The refrigerator of claim 1, wherein the front touch portion is below a front lower end of the lower cap.

3. The refrigerator of claim 1, wherein
the touch sensor further comprises:
a printed circuit board; and
a signal conductor on the printed circuit board and configured to transmit a touch signal to the printed circuit board,
wherein the bottom touch portion covers a lower side of the signal conductor, and
the front touch portion covers a front side of the signal conductor.

4. The refrigerator of claim 3, wherein the signal conductor is below the sensor mounting portion.

5. The refrigerator of claim 3, wherein the signal conductor is below a front lower end of the lower cap.

6. The refrigerator of claim 3, wherein the signal conductor extends from the printed circuit board toward the front touch portion.

7. The refrigerator of claim 3, wherein
the touch sensor comprises a sensor case coupled to the sensor mounting portion and supporting the printed circuit board and the signal conductor,
the bottom touch portion is on a lower surface of the sensor case, and
the front touch portion is on a front surface of the sensor case.

8. The refrigerator of claim 7, wherein the sensor case comprises a retaining rib configured to press the signal conductor toward the bottom touch portion from an upper side of the signal conductor to secure the signal conductor.

9. The refrigerator of claim 3, wherein the signal conductor comprises a conductive material, and is configured to be elastically deformable.

10. The refrigerator of claim 1, wherein
the touch sensor comprises a sensor case on to the sensor mounting portion,
the sensor case comprises a stepped portion stepped such that a front end of the lower cap is seated, and
the stepped portion contacts a lower surface and a rear surface of the front end of the lower cap.

11. The refrigerator of claim 10, wherein the front touch portion extends downwardly from the stepped portion.

12. The refrigerator of claim 1, wherein
the touch sensor comprises a sensor case,
the sensor mounting portion is formed by recessing upwardly from an opening on a lower surface of the lower cap such that a first portion of the sensor case is inserted, and
a second portion of the sensor case protrudes to an outside of the sensor mounting portion through the opening of the sensor mounting portion.

13. The refrigerator of claim 12, wherein
the bottom touch portion is on a lower surface of the sensor case on a lower side of the opening, and
the front touch portion is on a front surface of the sensor case on the lower side of the opening.

14. The refrigerator of claim 10, wherein
an upper portion of the sensor case is in the sensor mounting portion and coupled to the lower cap.

15. The refrigerator of claim 1, wherein
the door is an upper door, and
the refrigerator further comprises a lower door below the upper door and vertically aligned with the upper door,
wherein an upper end of the lower door is spaced apart from the front touch portion and the bottom touch portion.

16. A refrigerator, comprising:
a main body defining a storage compartment;
a door configured to open or close at least a portion of the storage compartment; and
a door opening device configured to open the door, wherein the door comprises:
a lower cap on a first portion of the door and comprising a handle and a sensor mounting portion in front of the handle;
a touch sensor coupled to the sensor mounting portion and configured to receive a touch signal to operate the door opening device, and
wherein the touch sensor comprises:
a printed circuit board, and a signal conductor on the printed circuit board and below the sensor mounting portion, the signal conductor configured to transmit a touch signal to the printed circuit board.

17. The refrigerator of claim 16, wherein the touch sensor further comprises:
a sensor case coupled to the sensor mounting portion and supporting the printed circuit board and the signal conductor, wherein the sensor case comprises:
a bottom touch portion covering the signal conductor from a first direction, and a front touch portion below the sensor mounting portion and covering the signal conductor from a second direction, and
wherein the signal conductor is configured to transmit a touch signal input from the bottom touch portion side or a touch signal input from the front touch portion side to the printed circuit board.

18. A refrigerator, comprising:
a main body defining a storage compartment;
a door configured to open or close at least a portion of the storage compartment; and
a door opening device configured to open the door, wherein the door comprises:
a door panel defining a surface of the door;
a lower cap on a first side of the door panel and comprising a handle and a sensor mounting portion in front of the handle and recessed upwardly from an opening; and
a touch sensor in the sensor mounting portion and configured to receive a touch signal to operate the door opening device, wherein the touch sensor comprises:
a bottom touch portion in the opening of the sensor mounting portion and configured to receive a touch signal from a first side of the touch sensor.

19. The refrigerator of claim 18, wherein the touch sensor further comprises:
a printed circuit board, and a signal conductor on the printed circuit board above the opening of the sensor mounting portion, and configured to transmit a touch signal input from the bottom touch portion side to the printed circuit board, wherein the bottom touch portion covers a first side of the signal conductor.

20. The refrigerator of claim 18, wherein the touch sensor comprises a sensor case in the sensor mounting portion, and
wherein the bottom touch portion is on a first surface of the sensor case, and wherein a second surface of the sensor case is covered by the lower cap.
